(19) United States
(12) Patent Application Publication
(10) Pub. No.: US 2025/0110036 A1
(43) Pub. Date: Apr. 3, 2025

(54) PERMEABILITY PREDICTION METHOD BASED ON ANISOTROPIC FLOW MODEL OF POROUS MEDIUM

(71) Applicant: KOREA GAS CORPORATION, Daegu (KR)

(72) Inventor: Chang Hoon SHIN, Suwon-si Gyeonggi-do (KR)

(73) Assignee: KOREA GAS CORPORATION, Daegu (KR)

(21) Appl. No.: 18/978,198

(22) Filed: Dec. 12, 2024

Related U.S. Application Data
(63) Continuation of application No. PCT/KR2022/020864, filed on Dec. 20, 2022.

(30) Foreign Application Priority Data
Aug. 29, 2022 (KR) 10-2022-0108066

(51) Int. Cl. G01N 15/08; G06F 17/11

(52) U.S. Cl. CPC G01N 15/0826; G01N 15/088; G06F 17/11; G01N 2015/0833

(57) ABSTRACT

Provided a method of predicting permeability of porous material based on anisotropic flow model. The method of predicting permeability of porous material based on anisotropic flow model comprises: providing a porous medium; establishing a concentric annulus flow model for the porous medium; calculating a concentric annulus cylinder interstitial flow velocity, a concentric annulus cylinder hydraulic tortuosity, and a concentric annulus cylinder hydraulic diameter using the concentric annulus flow model; and predicting a permeability for the porous medium using the concentric annulus cylinder hydraulic tortuosity and the concentric annulus cylinder hydraulic diameter.

### CROSS-REFERENCE TO RELATED APPLICATIONS

This application is a continuation of International Application No. PCT/KR2022/020864 filed on Dec. 20, 2022, which claims priority to Korean Patent Application No. 10-2022-0108066 filed on Aug. 29, 2022, the entire contents of which are herein incorporated by reference.

### FIELD OF INVENTION

The present invention relates to method for analysing flow in a porous medium, and more particularly, method for predicting permeability based on an anisotropic flow model of a porous medium.

The present invention is proposed with reference to Energy Resource Convergence Source Technology Development Project No. 20132510100060 and No. 20172510102150 supported by the Korea Institute of Energy Technology Evaluation and Planning (KETEP), granted financial resource from the Ministry of Trade, Industry & Energy, Republic of Korea.

### BACKGROUND OF INVENTION

Flow analysis in porous media has long been studied, primarily focusing on the development and production of groundwater, oil reservoirs, or gas reservoirs. In the 2000s, it regained significant attention with the commercialization of technologies for developing new oil and gas resources, such as shale gas and tight oil. Recently, the scope of research has expanded to include purposes such as carbon dioxide geological storage (CCS) and underground storage of natural gas or hydrogen. From another perspective, porous media flow has been applied to the development of efficient devices in fields like heat transfer, flow control, water purification, and refining processes, finding applications across various industries, including mechanical, chemical, electrical, and electronic engineering. Particularly, there has been growing interest in its applications in emerging areas such as biomechanics, membrane technology, and the development of microfluidic devices.

Despite this, the theoretical framework for flow analysis in porous media has not seen significant advancements since the development of Darcy's equation in 1852, Kozeny's equation in 1927, and the Kozeny-Carman equation in 1938. This stagnation is primarily due to the highly complex internal structure of porous media, which features microscopic and nanoscopic scales and is often opaque, making it difficult to accurately observe the internal pathways and flow properties. Furthermore, this lack of precise internal information poses challenges in rigorously developing flow theories for porous media and in defining and verifying the exact concepts and roles of state variables.

### SUMMARY OF INVENTION

### Technical Problem to be Solved

A technical task to be achieved by the technical spirit of the present invention is to provide provides a method of predicting permeability of porous material based on anisotropic flow model.

However, the scope of the present invention is not limited thereto.

### Technical Solution

According to an aspect of the present invention, there is provided a method of predicting permeability of porous material based on anisotropic flow model may include providing a porous medium; establishing a concentric annulus flow model for the porous medium; calculating a concentric annulus cylinder interstitial flow velocity, a concentric annulus cylinder hydraulic tortuosity, and a concentric annulus cylinder hydraulic diameter using the concentric annulus flow model; and predicting a permeability for the porous medium using the concentric annulus cylinder hydraulic tortuosity and the concentric annulus cylinder hydraulic diameter.

According to one embodiment of the present invention, the permeability may satisfy the following equation:

$$∴ k \approx \frac{Φ \cdot {D}_{ha}^{* 2} \cdot {T}^{2}}{32}$$

$$and$$

$${T}^{2} \approx {T}_{ca}^{2} = \frac{32 \cdot k}{Φ \cdot {D}_{ha}^{* 2}}$$

$$where$$

$${D}_{e} \approx {D}_{ha}^{*}$$

where k is permeability, φ is porosity, Dₕₐ* is a concentric annulus cylinder hydraulic diameter of the special concentric annulus flow model, T is hydraulic tortuosity, T_{ca} is concentric annulus cylinder hydraulic tortuosity, and Dₑ is an effective diameter.

According to one embodiment of the present invention, the concentric annulus cylinder interstitial flow velocity may satisfy the following equation:

$$∴ υ \approx {υ}_{ca} = \frac{u}{Φ {T}_{ca}} = \frac{u \cdot {D}_{ha}^{*}}{{( 32 \cdot Φ k )}^{0.5}} = {υ}_{a}^{*} \cdot {ξ}_{a}^{* \frac{1}{2}} \cdot {T}_{e}^{* \frac{1}{2}}$$

$$and$$

$${υ}_{ca} \approx {υ}_{ca Φ} = {υ}_{a}^{*} \cdot {ξ}_{α}^{* \frac{1}{2}} \cdot {( \frac{{Φ}_{a}}{Φ} )}^{2}$$

where, v is an interstitial flow velocity, v_{ca} is a concentric annulus cylinder interstitial flow velocity, u is an apparent flow velocity, φ is porosity, T_{ca} is concentric annulus cylinder hydraulic tortuosity, Dₕₐ* is a concentric annulus cylinder hydraulic diameter of the special concentric annulus flow model, k is permeability, vₐ* is an interstitial flow velocity of the special concentric annulus flow model, ξₐ* is a friction ratio of the special hydraulic concentric annulus flow model, Tₑ* is effective tortuosity of the special hydraulic cylinder model, and φₐ* is porosity of the special hydraulic concentric annulus flow model.

According to one embodiment of the present invention, a medium-scale flow rate and a pore-scale flow rate flowing through the porous medium may satisfy the following equation, thereby obtaining a first correlation between a diameter of a control volume and an effective diameter:

$${Q}_{u} = \frac{π {D}^{2}}{4} \cdot u {Q}_{υ} = \frac{π {D}_{h}^{2}}{4} \cdot υ ∴ {D}^{2} \cdot u = {D}_{h}^{2} \cdot υ ∵ {Q}_{u} = {Q}_{υ}$$

where, Qᵤ is a medium-scale flow rate, D is a diameter of a control volume, u is an apparent flow velocity, Qᵥ is a pore-scale flow rate, Dₑ is an effective diameter, and v is an interstitial flow velocity.

According to one embodiment of the present invention, a volume for the interstitial flow velocity and a volume for the apparent flow velocity flowing through the porous medium may satisfy the following equation, thereby obtaining a first correlation between a diameter of a control volume and the effective diameter:

$${V}_{u} = Φ \cdot \frac{π {D}^{2}}{4} \cdot L {V}_{υ} = \frac{π {D}_{e}^{2}}{4} \cdot {L}_{e} ∴ {D}_{e}^{2} \cdot = {D}^{2} \cdot Φ \cdot \frac{L}{{L}_{e}} ∵ {V}_{u} = {V}_{υ}$$

where, u is an apparent flow velocity, v is an interstitial flow velocity, Vᵤ is a volume based on u, φ is porosity, D is a diameter of a control volume, L is a porous medium length, Vᵥ is a volume based on v, Dₑ is an effective diameter, and Lₑ is an actual pore flow length.

According to one embodiment of the present invention, hydraulic tortuosity may be derived using the following equation established by the first correlation and the second correlation:

$$∴ T = \frac{u}{Φ υ} = \frac{L}{{L}_{e}} ∵ {D}^{2} \cdot u = {D}_{e}^{2} \cdot υ = {D}^{2} \cdot Φ \cdot \frac{L}{{L}_{e}} \cdot υ$$

where, T is hydraulic tortuosity, u is an apparent flow velocity, φ is porosity, v is an interstitial flow velocity, L is a porous medium length, Lₑ is an actual pore flow length, D is a diameter of a control volume, and Dₑ is an effective diameter.

According to one embodiment of the present invention, an effective diameter of the porous medium may satisfy the following equation:

$$∴ {D}_{e} = \frac{4 Φ}{{S}_{{S}_{e}}} = Φ \cdot \frac{{D}^{2}}{{D}_{e}} \cdot \frac{L}{{L}_{e}}$$

where, Dₑ is an effective diameter, φ is porosity, S_{Se} is an effective specific surface area, D is a diameter of a control volume, L is a porous medium length, and Lₑ is an actual pore flow length.

According to one embodiment of the present invention, an effective specific surface area of the porous medium may satisfy the following equation:

$${S}_{{S}_{e}} = \frac{{S}_{e}}{{V}_{b}} = \frac{π {D}_{e} \cdot {L}_{e}}{( π {D}^{2} / 4 ) \cdot L}$$

where, S_{Se} is an effective specific surface area, Sₑ is an effective surface area, V_{b} is a porous medium volume, Dₑ is an effective diameter, Lₑ is an actual pore flow length, D is a diameter of a control volume, and L is a porous medium length.

According to one embodiment of the present invention, an apparent flow velocity and permeability of the porous medium may satisfy the following equation:

$$u = - \frac{k}{μ} \frac{Δ P}{L}$$

$$and$$

$$k = \frac{2 {D}_{e}^{2}}{{f}_{u} {Re}_{{u}_{e}}}$$

where, u is an apparent flow velocity, k is permeability, μ is a fluid viscosity, ΔP is a pressure difference, L is a porous medium length, Dₑ is an effective diameter, fᵤₑ is an effective friction factor based on u, and Reᵤₑ is an effective Reynolds number based on u.

According to one embodiment of the present invention, the effective friction factor and the effective Reynolds number may satisfy the following equation:

$${f}_{{u}_{e}} = \frac{2 {D}_{e}}{ρ {u}^{2}} \frac{Δ P}{L}$$

$$and$$

$${Re}_{{u}_{e}} = \frac{ρ u {D}_{e}}{μ}$$

where, fᵤₑ is an effective friction factor based on u, Dₑ is an effective diameter, ρ is a fluid density, u is an apparent flow velocity, ΔP is a pressure difference, L is a porous medium length, Reᵤₑ is an effective Reynolds number based on u, Dₑ is an effective diameter, and μ is a fluid viscosity.

According to one embodiment of the present invention, the effective friction factor and the effective Reynolds number may satisfy the following equation:

$${f}_{{u}_{e}}^{2} = \frac{128 μ}{{ρ}^{2} {u}^{3} \cdot Φ {T}^{2}} \frac{Δ P}{L} {Re}_{{u}_{e}}^{2} = \frac{32 \cdot {ρ}^{2} {u}^{3}}{μ \cdot Φ {T}^{2}} \frac{L}{Δ P} ∵ {D}_{e} = \frac{{D}_{h}}{{( T \cdot ξ )}^{0.5}} ∴ {f}_{{u}_{e}} {Re}_{{u}_{e}} = \frac{64}{Φ {T}^{2}}$$

where, fᵤₑ is an effective friction factor based on u, μ is a fluid viscosity, ρ is a fluid density, u is an apparent flow velocity, φ is porosity, T is hydraulic tortuosity, ΔP is a pressure difference, L is a porous medium length, Reᵤₑ is an effective Reynolds number based on u, Dₑ is an effective diameter, Dₕ is a hydraulic diameter, and ξ is a friction ratio.

According to one embodiment of the present invention, the effective friction factor and the effective Reynolds number may satisfy the following equation:

$${f}_{u} = \frac{8 {τ}_{{w}_{u}}}{ρ {u}^{2}} ,$$

$${τ}_{{w}_{u}} = \frac{{D}_{e}}{4} \frac{Δ P}{L} = {τ}_{wpass} {Re}_{{u}_{e}} = \frac{ρ u {D}_{h}}{μ} {( \frac{Φ υ}{ξ u} )}^{\frac{1}{2}}$$

$$or$$

$${Re}_{{u}_{e}} = \frac{ρ u}{μ T} {( \frac{32 k}{Φ} )}^{\frac{1}{2}}$$

where, fᵤ is a friction factor based on u, τwᵤ is a wall shear stress based on u, ρ is a fluid density, u is an apparent flow velocity, Dₑ is an effective diameter, ΔP is a pressure difference, L is a porous medium length, τ_{WPSS} is a PSS wall shear stress, Reᵤₑ is an effective Reynolds number based on u, Dₕ is a hydraulic diameter, μ is a fluid viscosity, φ is porosity, v is an interstitial flow velocity, ξ is a friction ratio, T is hydraulic tortuosity, and k is permeability.

According to one embodiment of the present invention, the interstitial flow velocity and the permeability of the porous medium may satisfy the following equation:

$$υ = - \frac{2 {D}_{e}^{2}}{μ \cdot {f}_{e} {Re}_{e}} \frac{Δ P}{{L}_{e}}$$

$$and$$

$$\frac{Φ \cdot {D}_{e}^{2} \cdot {T}^{2}}{32}$$

where, v is an interstitial flow velocity, Dₑ is an effective diameter, μ is a fluid viscosity, fₑ is an effective friction factor, Reₑ is an effective Reynolds number, ΔP is a pressure difference, Lₑ is an actual pore flow length, k is permeability, φ is porosity, and T is hydraulic tortuosity.

According to one embodiment of the present invention, the effective friction factor and the effective Reynolds number may satisfy the following equation:

$${f}_{e} = \frac{2 {D}_{e}}{{ρ}^{{υ}^{2}}} \frac{Δ P}{{L}_{e}}$$

$$and$$

$${Re}_{e} = \frac{ρ υ {D}_{e}}{μ}$$

where, fₑ is an effective friction factor, Dₑ is an effective diameter, ρ is a fluid density, v is an interstitial flow velocity, ΔP is a pressure difference, Lₑ is an actual pore flow length, Reₑ is an effective Reynolds number, and μ is a fluid viscosity.

According to one embodiment of the present invention, the effective friction factor and the effective Reynolds number may satisfy the following equation:

$$∴ {f}_{e}^{2} = \frac{128 μ \cdot T}{{ρ}^{2} {υ}^{3}} \frac{Δ P}{L}$$

$$and$$

$${Re}_{e}^{2} = \frac{32 \cdot {ρ}^{2} {υ}^{3}}{μ \cdot T} \frac{L}{Δ p} ∴ {f}_{e} {Re}_{e} = {f}_{{u}_{e}} {Re}_{{u}_{e}} \cdot Φ {T}^{2} = 64$$

where, fₑ is an effective friction factor, μ is a fluid viscosity, T is hydraulic tortuosity, ρ is a fluid density, v is an interstitial flow velocity, ΔP is a pressure difference, L is a porous medium length, Reₑ is an effective Reynolds number, fᵤₑ is an effective friction factor based on u, Reᵤₑ is an effective Reynolds number based on u, and φ is porosity.

According to one embodiment of the present invention, the effective friction factor and the effective Reynolds number may satisfy the following equation:

$${f}_{υ} = \frac{8 {τ}_{{w}_{u}}}{ρ {υ}^{2}} ,$$

$${τ}_{{w}_{υ}} = \frac{{D}_{e}}{4} \frac{Δ P}{{L}_{e}} = {τ}_{wpass} \cdot T {Re}_{e} = \frac{ρ υ {D}_{h}}{μ} {( \frac{Φ υ}{ξ u} )}^{\frac{1}{2}}$$

$$or$$

$${Re}_{e} = \frac{ρ υ}{μ T} {( \frac{32 k}{Φ} )}^{\frac{1}{2}}$$

where, fᵤ is a friction factor based on v, τwᵥ is a wall shear stress based on v, ρ is a fluid density, v is an interstitial flow velocity, Dₑ is an effective diameter, ΔP is a pressure difference, Lₑ is an actual pore flow length, τ_{WPSS} is a PSS wall shear stress, T is hydraulic tortuosity, Reₑ is an effective Reynolds number, Dₕ is a hydraulic diameter, μ is a fluid viscosity, φ is porosity, ξ is a friction ratio, u is an apparent flow velocity, and k is permeability.

According to one embodiment of the present invention, the friction factor and the Reynolds number of the porous medium may satisfy the following equation:

$$∴ {f}_{p} {Re}_{p} = 16 + 0.1936 \cdot {Re}_{{p}^{′}}$$

$$where$$

$${f}_{p} ≡ \frac{{D}_{e} \cdot {Φ}^{2} {T}^{3}}{2 ρ {u}^{2}} \frac{Δ P}{L} {Re}_{p} ≡ \frac{ρ u {D}_{e}}{μ \cdot Φ T}$$

where, fₚ is a friction factor of the proppant packs, Reₚ is a Reynolds number of the proppant packs, Dₑ is an effective diameter, φ is porosity, T is hydraulic tortuosity, ρ is a fluid density, u is an apparent flow velocity, ΔP is a pressure difference, L is a porous medium length, and μ is a fluid viscosity.

According to one embodiment of the present invention, a pressure difference of the porous medium may satisfy the following equation:

$$∴ Δ P = ( 16 + 0.1936 \cdot \frac{ρ u \overline{{D}_{e}}}{μ \cdot Φ {T}^{2}} ) \frac{2 μ uL}{Φ \overline{{D}_{e}^{2}}} ∵ \overline{{D}_{e}} = {D}_{e} \cdot T {k}_{Daray} = \frac{Φ \cdot \overline{{D}_{e}} {}^{2}}{32}$$

where, ΔP is a pressure difference, ρ is a fluid density, u is an apparent flow velocity, [symbol] is a superficial effective diameter, μ is a fluid viscosity, φ is porosity, T is hydraulic tortuosity, L is a porous medium length, Dₑ is an effective diameter, k_{Darcy} is Darcy permeability, and k is permeability.

According to one embodiment of the present invention, permeability and hydraulic tortuosity of the porous medium may satisfy the following equation:

$$∴ k = \frac{Φ \overline{{D}_{e}^{2}}}{2 ( 16 + 0.1936 \cdot \frac{ρ u \overline{{D}_{e}}}{μ \cdot Φ {T}^{2}} )}$$

$$or$$

$${T}^{2} = \frac{0.1936 \cdot \frac{ρ u \overline{{D}_{e}}}{μ \cdot Φ {T}^{2}}}{( \frac{Φ \overline{{D}_{e}^{2}}}{2 k} - 16 )} ∵ u = \frac{k}{μ} \frac{Δ P}{L}$$

where, k is permeability, φ is porosity, D̅ₑ̅ is a superficial effective diameter, ρ is a fluid density, u is an apparent flow velocity, μ is a fluid viscosity, T is hydraulic tortuosity, ΔP is a pressure difference, and L is a porous medium length.

According to one embodiment of the present invention, the concentric annulus cylinder hydraulic diameter may be the same as the effective diameter of the porous medium, and the concentric annulus cylinder hydraulic tortuosity may be the same as the hydraulic tortuosity of the porous medium.

### Advantageous Effects

Fluid flow through porous media is defined by permeability, whose correlation is typically determined by the Kozeny-Carman equation using geometric variables, such as hydraulic diameter and tortuosity. The hydraulic tortuosity was first described by Kozeny, and later redefined by Carman as the tortuosity square term in the Kozeny-Carman equation. However, it gives the ambiguous physical correlation between tortuosity and permeability, which do not properly reflect anisotropic frictional flow features.

In the method for predicting permeability based on an anisotropic flow model of a porous medium according to the technical spirit of the present invention, the Kozeny-Carman equation was theoretically and experimentally verified to obtain the proper correlation based on their exact definitions. Therefore, the effective variables of porous media were presented, and it confirmed that the effective diameter corresponded to the physically equivalent diameter of porous media. Moreover, using the mass conservation relation, Kozeny's tortuosity was verified to be reasonably associated with the truly equivalent flow model, and hence, vital for anisotropic porous flow analyses. Furthermore, the Kozeny-Carman equation was revised appertaining either effective diameter or tortuosity, and the momentum conservation relation was used to verify it. The pore-scale simulations using 5-sorts of 25-series porous media models were performed to test the validity of derived effective variables and revised equations. Finally, the equivalent model of porous media was presented for anisotropic flow analyses using truly equivalent geometric and frictional flow variables. Subsequently, their practical approximations were achieved by introducing the concentric annulus flow model. The new variables and relations are expected to be usefully adopted in various porous flow analyses, such as geometric condition variations, flow regime changes, and anisotropic heat and multiphase flows.

Accordingly, when the theory of the present invention is applied to the development and production of actual hydrocarbon reservoirs (particularly shale/tight formations), more reliable and scalable results may be expected. In particular, it is anticipated that this will enable accurate estimation of petroleum/gas reserves, optimal well development planning, and appropriate assessment of investment and operating costs for production facilities, thereby contributing to enhanced economic viability and strengthened technical prominence of related projects.

The above-described effects are merely examples and the scope of the present invention is not limited thereto.

### BRIEF DESCRIPTION OF DRAWINGS

FIG. 1 is a schematic diagram showing hydraulic variables and effective variables based on a cylindrical medium in the method of predicting permeability of porous material based on anisotropic flow model, according to an embodiment of the present invention.

FIG. 2 shows a simple porous medium model for pore-scale simulation in the method of predicting permeability of porous material based on anisotropic flow model, according to an embodiment of the present invention.

FIGS. 3 and 4 shows a complex porous medium model for pore-scale simulation in the method of predicting permeability of porous material based on anisotropic flow model, according to an embodiment of the present invention.

FIG. 5 is a table showing key geometric shape information for performing the pore-scale simulation of the simple porous medium model in the method of predicting permeability of porous material based on anisotropic flow model, according to an embodiment of the present invention.

FIG. 6 is a table showing key pore-scale simulation results of the simple porous medium model in the method of predicting permeability of porous material based on anisotropic flow model, according to an embodiment of the present invention.

FIG. 7 is a table showing key geometric shape information for performing the pore-scale simulation of the complex porous medium model in the method of predicting permeability of porous material based on anisotropic flow model, according to an embodiment of the present invention.

FIGS. 8 through 10 show streamline distributions derived from the pore-scale simulation results in the method of predicting permeability of porous material based on anisotropic flow model, according to an embodiment of the present invention.

FIG. 11 show a concentric annulus flow model in the method of predicting permeability of porous material based on anisotropic flow model, according to an embodiment of the present invention.

FIG. 12 is a table showing variables derived from the pore-scale simulation results in the method of predicting permeability of porous material based on anisotropic flow model, according to an embodiment of the present invention.

FIG. 13 is a graph comparing the wall shear stress derived from the pore-scale simulation results with the wall shear stress from the calculations in the method of predicting permeability of porous material based on anisotropic flow model, according to an embodiment of the present invention.

FIG. 14 is a graph comparing hydraulic tortuosity, the reciprocal of the friction ratio, and effective tortuosity in the method of predicting permeability of porous material based on anisotropic flow model, according to an embodiment of the present invention.

FIG. 15 is a table showing variables derived from the pore-scale simulation results using the special concentric annulus flow model in the method of predicting permeability of porous material based on anisotropic flow model, according to an embodiment of the present invention.

FIG. 16 is a graph comparing interstitial flow velocities in the method of predicting permeability of porous material based on anisotropic flow model.

FIGS. 17 and 18 are graphs showing permeability for apparent flow velocity in the method of predicting permeability of porous material based on anisotropic flow model, according to an embodiment of the present invention.

FIG. 19 is a flowchart of a method of predicting permeability of porous material based on anisotropic flow model, according to an embodiment of the present invention.

### DETAILED DESCRIPTION OF INVENTION

Hereinafter, preferred embodiments of the present invention will be described in detail with reference to the accompanying drawings. The embodiments of the present invention are provided to more completely explain the technical spirit of the present invention to those skilled in the art, and the following examples may be modified in various different forms, and the scope of the technical spirit is not limited to the following examples. Rather, these embodiments are provided so that this disclosure will be thorough and complete, and will fully convey the spirit of the invention to those skilled in the art. Like reference numerals throughout this specification mean like elements. Furthermore, various elements and areas in the drawings are schematically drawn. Therefore, the technical spirit of the present invention is not limited by the relative size or spacing drawn in the accompanying drawings.

Accurate flow analyses of various porous media, such as nano-fluidic membranes (Cheng et al., 2018), foam materials (Deng et al., 2017), ground reservoirs (Berkowitz, 2002; Gaol et al., 2021; Jeong et al., 2018) of water, oil, and gas, heat transfer devices (Alomar et al., 2017; Dong et al., 2017), biological materials (Thullner, 2018), purification filters (Zhou et al., 2020), and flow control units (Nemeca and Levec, 2005), have been one of the most crucial issues in various industrial applications. Physical filtration occurs when microbes are removed from the solution caused by attachment and sedimentation (Gaol et al., 2021). The attachment process is strongly related to biological processes, particularly microbial growth, and then forms a biofilm that reduces the pore size and permeability of porous media. The straining process or mechanical trapping occurs when the pore throats are too narrow for microbes to flow (Thullner, 2018; Zhou et al., 2020).

The reduction of pore space leading to a decrease in porous medium permeability, generally referred to as clogging, may be a critical problem for some applications or a benefit for others, depending on its objectives (Jeong et al., 2018). Understanding of clogging processes in porous media is essential for environmental and petroleum engineering applications, including aquifer storage and recovery, underground hydrogen storage, and enhanced oil recovery (Gaol et al., 2021).

Moreover, multiphase flow behavior and heat transfer features of artificial porous materials are important factors in the recently developed carbon nano-tubes, microelectronics, heat exchangers, and thermal power plants. Increasing the heat transfer rate with a reduction in the cost and size is a critical issue in several engineering applications. Liquid-vapor phase change processes within porous media occur in numerous applications, where they are often driven by a complex interaction of gravitational, capillary, and viscous forces (Alomar et al., 2017). The anisotropy of permeability and thermal conductivity considerably effects on the initiation and termination of the phase change process and heat transfer rate compared with those under isotropic conditions. The efficiency of volumetric porous media receivers in concentrated solar power plants is sensitive and highly affected by heat transfer and flow properties in porous media solar thermochemical reactor (Pelay et al., 2017; Zhu and Xuan, 2017).

Nevertheless, the anisotropic flow theory of porous media has not adequately progressed (Erdim et al., 2015; Ma, 2015), after the Kozeny-Carman equation was proposed as a fundamental equation of creeping flow phenomena through porous media in the Darcy flow regime (Bear, 1975; Neild and Bejan 1992). The hydraulic tortuosity was first described by Kozeny for reflecting anisotropic flow features, and later redefined by Carman as the tortuosity square term in the Kozeny-Carman equation. The rational correlation between the basic porous flow variables, such as hydraulic diameter, tortuosity, and permeability is the most vital factor for optimal facility designs, economic productions, and ecofriendly developments in the various engineering applications. Many studies recommended various modifications to the Kozeny-Carman equation to improve its applicability and accuracy (Achdou and Avelaneda, 1992; Paterson, 1983; Shin, 2017; Shin, 2019; Walsh and Brace 1984). However, significant advances in the anisotropic porous flow theory have yet been reported (Erdim et al., 2015; Ma, 2015), and accurate porous flow analyses remain one of the major pitfalls in fluid physics and various industrial applications of porous media.

The fundamental and critical reasons are the extreme difficulty in measuring internal structures and flow properties passing through micro, complex, and invisible pores of porous media. As a result, the physical concepts and definitions of crucial variables in fundamental equations, such as the Kozeny-Carman equation, have been widely used without being thoroughly verified. Furthermore, even within the same material, porous flows may vary significantly due to simple flow direction alterations (different flow paths), resulting in a large number of equivalent diameters (flow sections) and pathlengths (tortuosity) for individual flow directions (Shin, 2017; Shin, 2019). This implies that the anisotropic frictional flow characteristics through porous media must be defined more precisely based on their equivalent flow models, particularly using the truly equivalent path diameter and length (tortuosity).

However, the Kozeny-Carman equation was described considering only the hydraulic tortuosity in combination with several other constant factors fixed in a single material, such as hydraulic diameter and porosity. Accordingly, Shin (2021) suggested adopting the effective diameter concept, which has been broadly used for conventional pipe flow analyses, into porous flow analyses to exactly define the anisotropic flow model of porous media. However, the concept was simply applied for flow variation analyses owing to geometric condition changes without presenting the theoretical derivations, experimental verifications, and practical applications. Moreover, the essential variables, such as the effective diameter and hydraulic tortuosity, cannot be determined in reality because the interstitial flow velocity passing through anisotropic, invisible, and microscopic pores of huge and heterogeneous ground formations is almost impossible.

Furthermore, for porous flow theory, many distinct definitions of each fundamental variable have been presented (Bear, 1975; Erdim et al., 2015; Ma, 2015; Neild and Bejan 1992). For example, various definitions of the Reynolds number were proposed based on different diameters and velocities, including hydraulic, grain, and medium diameters or internal, superficial, and apparent velocities. To be appropriately employed as the basic criteria in porous flow analyses, the Reynolds number must be consistently defined using truly equivalent diameter and velocity. Tortuosity is another key variable in describing porous flows. However, there are two distinct types of tortuosity (path length) definitions, namely, Kozeny's and Carman's. It is not the only critical problem in the correlations of flow velocity and path length because the path length must be correlated to the path diameter for a given flow rate. Therefore, if the hydraulic tortuosity is inaccurate, an unreasonable frictional flow model may be defined based on the inaccurate equivalent path length and diameter, which in turn affects other key characteristic variables of porous flows, such as the Reynold number, Darcy friction factor, and Kozeny constant. The ambiguous definition and correlation could be major drawbacks to important advances in various porous flow analyses, such as heat transfer, clogging process, physical filtration, chemical dissolution, multiphase behavior, and non-Darcy flow analyses; hence, they must be clarified.

### Different Definitions of Tortuosity and Permeability

The permeability (k) is determined by the Darcy equation based on the measured pressure difference (ΔP) and the apparent flow velocity (u), and the Darcy equation is shown in the following Equation 1.

$$\begin{matrix}〈 Equation 1 〉 & \\ u = - \frac{k}{μ} \frac{Δ P}{L} & \end{matrix}$$

$$and$$

$$k = \frac{2 {D}_{h}^{2}}{{f}_{u} {Re}_{u}}$$

$$where$$

$${f}_{u} = \frac{2 {D}_{h}}{ρ {u}^{2}} \frac{Δ P}{L}$$

$$and$$

$${Re}_{u} = \frac{ρ u {D}_{h}}{μ}$$

In Equation 1, u is an apparent flow velocity, k is permeability, μ is a fluid viscosity, ΔP is a pressure difference, L is a porous medium length, Dₕ is a hydraulic diameter, fᵤ is a friction factor based on u, Rᵤ is a Reynolds number based on u, and ρ is a fluid density.

The relationship between permeability and the friction constant (fRe) may be expressed simply by using the Darcy friction factor (f) and Reynolds number (Re) correlations based on the apparent flow variables,

Alternatively, the Kozeny-Carman equation (Equation (2)) may be introduced and defined using the hydraulic diameter (Dₕ=4φ/S_{S}) and hydraulic tortuosity (T=L/Lₑ), the ratio (L/Lₑ) of porous medium length (L) to actual flow length (Lₑ); i.e., averaged flow path length of porous medium (Bear, 1975; Carman, 1938; Kozeny, 1927; Neild and Bejan 1992).

$$\begin{matrix}〈 Equation 2 〉 & \\ u = - \frac{Φ}{μ} ( \frac{{D}_{h}^{2}}{16 {C}_{K}} ) ( \frac{Δ P}{L} ) {( \frac{L}{{L}_{e}} )}^{2} = {Φ}_{υ {T}^{2}} & ( a )\end{matrix}$$

$$where$$

$${T}^{2} = {( \frac{L}{{L}_{e}} )}^{2} = \frac{u}{Φ υ} = ( - \frac{k}{μ} \frac{Δ P}{L} ) \frac{1}{Φ υ}$$

$$∴ {k}_{C} = \frac{{D}_{h}^{2} \cdot Φ {T}^{2}}{16 {C}_{K}} \qquad ( b )$$

$$or$$

$${k}_{C} = \frac{{Φ}^{3}}{{S}_{S}^{2}} ( \frac{{T}^{2}}{{C}_{K}} )$$

$$where$$

$${D}_{h} \frac{4 Φ}{{S}_{S}} = \frac{4 {D}_{m} Φ}{{C}_{S} ( 1 - Φ )}$$

In Equation 2, u is an apparent flow velocity, φ is porosity, μ is a fluid viscosity, Dₕ is a hydraulic diameter, C_{K} is a Kozeny constant, ΔP is a pressure difference, L is a porous medium length, Lₑ is an actual pore flow length, T is hydraulic tortuosity, v is an interstitial flow velocity, k_{C} is Carman permeability, S_{S} is a specific surface area, Dₘ is a grain diameter, C_{S} is a cross section shape constant, and Rₕ is a hydraulic diameter.

Here, the Kozeny constant (C_{K}) must be provided for the flow analyses (Carman, 1938; Kozeny, 1927; Ozugumus et al., 2014), however, determining this constant is difficult. Literature review (Costa, 2006; Guo et al., 2021; Nooruddin and Hossain, 2012; Safari et al., 2021; Valdez-Parada et al., 2009; Wei et al., 2018) shows that the determination of the Kozeny constant is a widely investigated topic. The Kozeny constant was assigned a value of 2.0±0.15 (i.e., C_{K}/T²=4.8±0.3) by Carman for packed beds with uniform spheres, whereas Ergun proposed a value of 150 for the Blake-Kozeny constant. Xu and Yu devised an analytical expression to determine the permeability in a homogeneous porous medium with solid bars. In addition, Heijs and Lowe studied the change in the Kozeny constant with porosity for a random array of spheres and a clay soil. Gamrat et al. looked at two-dimensional cylinders in inline and staggered arrangements, Karimian and Straatman looked at a metal foam structure, and Liu and Hwang investigated fibrous porous media. Some researchers proposed using a fixed value for the Kozeny constant, whereas others established a relationship between this constant and porosity. However, these approaches are still insufficiently accurate because the Kozeny constant is complicatedly related to several parameters, including porosity, tortuosity, pore-throat size, particle geometry and uniformity, and pore structure periodicity and isotropy (Allen, 2013; Almadi et al, 2011; Sobieski et al., 2012; Vogel, 2000).

Following the assertion that the granular bed is equivalent to a group of similar parallel channels (Kozeny, 1927; Carman, 1938), Kozeny initially presented Equations 3(a) and 3(b) by substituting the tortuosity concept with the pressure gradient term of the modified Darcy's equation by Blake (1922). Subsequently, Fair and Hatch (1933) demonstrated that the Kozeny constant depends on the shape of the cross-section of each channel, and is defined as the constant in the general law of streamline motion through channels of uniform but noncircular cross-sections. It corresponds to doubling the value of the friction constant ratio (ξ=fᵥReᵥ/64) in Equation 3(c), which is essentially defined in conventional viscous flow dynamics of normal pipes (White, 2001; Shah and London, 1979) as the ratio of laminar friction constant (fᵥReᵥ) of noncircular cross-section to that of a circular cylinder (fRe=64); i.e., C_{K}=2ξ.

$$\begin{matrix}〈 Equation 3 〉 & \\ {υ}_{S} = \frac{u}{Φ} = ( - \frac{{D}_{h}^{2}}{μ \cdot 16 {C}_{K}} \frac{Δ P}{L} ) {( \frac{L}{{L}_{e}} )}^{2} = υ T ∴ T = \frac{L}{{L}_{e}} = \frac{u}{Φ υ} & ( a )\end{matrix}$$

$$or$$

$$u = Φ υ T$$

$$∴ {k}_{k} = \frac{{D}_{h}^{2} \cdot Φ T}{16 {C}_{K}} \qquad ( b )$$

$$or$$

$${k}_{k} = \frac{{Φ}^{3}}{{S}_{S}^{2}} ( \frac{T}{{C}_{K}} )$$

$$where \qquad ( c )$$

$$ξ = \frac{{f}_{υ} {Re}_{υ}}{64} = \frac{{C}_{K}}{2}$$

$$and$$

$${f}_{υ} = \frac{2 {D}_{h}}{{ρ}^{{υ}^{2}}} \frac{Δ P}{L} {Re}_{υ} = \frac{ρ υ {D}_{h}}{μ}$$

In Equation 3, vₛ is a superficial flow velocity, u is an apparent flow velocity, φ is porosity, Dₕ is a hydraulic diameter, μ is a fluid viscosity, C_{K} is a Kozeny constant, ΔP is a pressure difference, L is a porous medium length, Lₑ is an actual pore flow length, v is an interstitial flow velocity, T is hydraulic tortuosity, k_{K} is Kozeny permeability, S_{S} is an specific surface area, ξ is a friction ratio, fᵤ is a friction factor based on v, Reᵥ is a Reynolds number based on v, and ρ is a fluid density.

The Kozeny relationship in Equation 3 rigorously and appropriately defines the relationship between the geometric properties and flow characteristics of porous media. However, the friction constant ratio (ξ), often referred to as the Kozeny constant (C_{K}), is actually a variable that differs for each medium and even for different flow directions within the same medium. As a result, it is considered practically impossible to precisely determine this constant.

Later, Carman (1938) suggested the Kozeny-Carman equation, as indicated in Equations 2(a) and 2(b), further adopting the tortuosity definition into the superficial velocity term (vₛ) in Equation 3(a). Additionally, Carman argued that the Kozeny constant could be assumed to be approximately C_{K}=² in most cases. This assumption appears to be reasonably applicable to common media with relatively simple structures. Consequently, since 1938, the Kozeny-Carman equation has been widely used as a fundamental relationship in the analysis of porous media flow.

Taking much of the success in applying poiseuille's law to granular beds into consideration, Carman contended that “C_{K}=2” does not necessarily denote a circular cross-section, or even a shape resembling a circle: C_{K}≈2 for granular beds. In addition, the time taken for such an element of fluid to pass over a sinuous track of length, Lₑ, at the velocity, (uLₑ/φL), corresponds to that taken to pass over a distance, L, at a velocity, (u/φ). As a result, the tortuosity definition from the Kozeny-Carman equation, T²=(L/Lₑ)²=u/φv, instead of Kozeny's definition, T=L/Lₑ=u/φv, has been accepted as the fundamental correlation in porous flow analyses until now presented (Bear, 1975; Erdim et al., 2015; Ma, 2015; Neild and Bejan 1992). The striking difference between Kozeny's and Carman's equations may be identified from the differently resulting expressions of tortuosity in Equations 3(a) and 2(a), respectively. Furthermore, varying permeability descriptions in the order of tortuosity derived from the respective equations are observed in Equations 3(b) and 2(b); k_{K}=f(T) vs k_{C}=f(T²).

Because the friction ratios (ξ) of most granular beds cannot be equal to that of the circular cylinder (ξ=C_{K}/2≠1), we had to ensure that Carman's modifications were physically sound. The successes in applying poiseuille's law might be limited to a few easily structured packs. Moreover, Carman's tortuosity definition presents an ambiguous physical relationship, u/φv=(L/Lₑ)². Basically, flow velocity is proportional to the flow path length but not the length square because the flow volume through the identical pore space (product of cross-sectional area and length) in a unit time must be equal regardless of either microscopic (pore-scale) or macroscopic (medium-scale) viewpoints.

In other words, two questions may be presented for Carman's argument described above. First, the assumption of C_{K}≈2 presupposes the assumption that porous flow is approximately equivalent to cylindrical capillary flow. This is because fᵥReᵥ=64. However, in reality, the cases where porous flow passing through a very complex pore channel may be approximated as a cylinder are likely to be limited to some cases with relatively simple channel structures. Next, according to this assumption, Equation 3 is defined as a somewhat vague concept that hydraulic tortuosity is proportional to the square of the flow path length, which is the correlation of the flow velocity is proportional to the square of the flow distance. That is, T²=(L/Lₑ)²=u/φv. As a result, the Carman relation of Equation 2 calculates a definition of tortuosity and permeability that is different from the Kozeny relation of Equation 3, and may be considered as an approximated relation based on the cylindrical flow model.

As mentioned above, the Kozeny relation has the problem of difficulty in determining the Kozeny constant, but it is rigorous and valid in terms of physical concepts and theoretical development. However, the validity of the tortuosity (interstitial flow velocity) correlation presented by modifying the Carman relation needs to be verified by the appropriateness of the theoretical development and by actually measuring the porous flow properties. Ultimately, this is to verify the rigorous correlation between the geometric properties and the flow characteristics of the porous medium, that is, the permeability relation. Here, one more issue to consider is the appropriateness of the hydraulic diameter introduced when defining the porous media flow. Again, the Kozeny relation is considered a rigorous relation, but it is considered a different issue from the perspective of whether it is sufficient as a relation that properly expresses the actual porous media frictional flow loss in reality. For example, in different porous media with very complex particle structures, sizes, and arrangements, the hydraulic diameter representing each medium is bound to be different.

On the other hand, two cases are considered where the flow direction is horizontal and vertical based on the same anisotropic medium. In these two cases, an interstitial flow velocity distribution and a pressure drop in each flow direction may be clearly different. Nevertheless, the hydraulic diameters of the two cases are the same because they are defined only by the quantitative variables of the same anisotropic medium, such as porosity and specific surface area. Then, it is questionable whether it is physically valid for two cases with different flow characteristics to be defined by the same hydraulic diameter. The hydraulic diameter is an essential and core characteristic variable along with the definition of the Reynolds number that divides the flow region, the friction factor (Darcy Friction Factor) defined as an index of friction performance of each medium, and the interstitial flow velocity. In other words, tortuosity is an essential and key variable in the definition of the friction coefficient. Therefore, when the hydraulic diameter or tortuosity (interstitial flow velocity) is not properly defined and applied, it will be difficult to properly define the flow loss, heat transfer, diffusion, and adsorption/desorption characteristics of each porous frictional flow. Furthermore, in the development of unconventional oil/gas development, underground storage, and variable micro flow control devices that have been actively developed recently, it is essential to define and present a flow model (variable) that may properly reflect the flow characteristics of each medium in the analysis of changes in the flow domain and geometrical characteristics, which are issues.

Therefore, the mass and momentum conservation equations of porous media are derived to clarify the unclear definitions in the subsequent section.

### Mass Conservation Equation and Momentum Conservation Equation

The mass conservation law for an incompressible fluid flow is introduced in Equation 4(a) to examine the definition of hydraulic tortuosity.

$$\begin{matrix}〈 Equation 4 〉 & \\ {Q}_{u} = \frac{π {D}^{2}}{4} \cdot u {Q}_{υ} = \frac{π {D}_{h}^{2}}{4} \cdot υ ∴ {D}^{2} \cdot u = {D}_{h}^{2} \cdot υ ∵ {Q}_{u} = {Q}_{υ} & ( a )\end{matrix}$$

$${D}_{h} = \frac{4 Φ}{{S}_{S}} = Φ \cdot \frac{{D}^{2}}{{D}_{h}} \cdot \frac{L}{{L}_{e}} ∴ {D}_{h}^{2} = {D}^{2} \cdot Φ \cdot \frac{L}{{L}_{e}} ∵ {S}_{S} = \frac{S}{{V}_{b}} = \frac{π {D}_{h} \cdot {L}_{e}}{( π {D}^{2} / 4 ) \cdot L} \qquad ( b )$$

$$∴ T = \frac{u}{Φυ} = \frac{L}{{L}_{e}} ∵ {D}^{2} \cdot u = {D}_{h}^{2} \cdot υ = {D}^{2} \cdot Φ \cdot \frac{L}{{L}_{e}} \cdot υ \qquad ( c )$$

In Equation 4, Qᵤ is medium-scale flow rate, D is a diameter of a control volume, u is an apparent flow velocity, Qᵥ is pore-scale flow rate, Dₕ is a hydraulic diameter, v is an interstitial flow velocity, φ is porosity, S_{S} is a specific surface area, L is a porous medium length, Lₑ is an actual pore flow length, and T is hydraulic tortuosity.

In Equation 4(a), the volumetric flow rates on both medium- and pore-scales, entering through the identical flow control volumes of the target porous media, must be equivalent. The medium-scale flow rate (Qᵤ) is depicted using the apparent velocity (u) and original diameter (D) of the cylindrical control volume. Otherwise, the pore-scale flow rate (Qᵥ) is defined using the average internal flow velocity (v) and hydraulic diameter (Dₕ) of the cylindrical control volume; i.e., the equivalent pore-scale flow model is detailed using the hydraulic diameter and tortuosity to possess the identical frictional flow features, such as the same pressure difference (ΔP) and internal flow velocity (v) for the given flow rate (Qᵤ=Qᵥ). Subsequently, based on the definition of hydraulic diameter, the geometric relation between a diameter of a control volume (D) and hydraulic diameter (Dₕ) is derived, as shown in Equation 4(b). As a result, by combining both relations in Equations 4(a) and 4(b), the exact definition of tortuosity is obtained from Equation 4(c), which is identical to Kozeny's tortuosity definition in Equation 3(a).

Furthermore, the resulting velocity relation (v=u/φT) in Equation 4(c) is integrated to the Darcy equation (macroscopic momentum conservation law) in Equation 1 to derive the microscopic (pore-scale) momentum equation shown in Equation 5(a).

$$〈 Equation 5 〉$$

$$\begin{matrix}∴ v = - \frac{2 {D}_{h}^{2}}{μ \cdot {f}_{v} {Re}_{v}} \frac{Δ P}{L} & ( a ) \\ \begin{matrix}∴ v = \frac{u}{∅ T} \\ \\ {f}_{v} {Re}_{v} = {f}_{u} {Re}_{u} \cdot ∅ T = ( \frac{2 {D}_{h}^{2}}{μ v \cdot ∅ T} \frac{Δ P}{L} ) \cdot ∅ T\end{matrix} & \\ ∴ k = \frac{{D}_{h}^{2} \cdot ∅ T}{16 {C}_{K}} = \frac{{∅}^{3}}{{S}_{s}^{2}} ( \frac{T}{{C}_{K}} ) & ( b ) \\ where & \\ ξ = \frac{{f}_{v} {Re}_{v}}{64} = \frac{{C}_{K}}{2} , & \\ {f}_{v} = \frac{2 {D}_{h}}{{ρ}^{{v}^{2}}} \frac{Δ P}{L} & \\ ∵ {Re}_{v} = \frac{ρ v {D}_{h}}{μ} & \end{matrix}$$

In Equation 5, v is an interstitial flow velocity, Dₕ is a hydraulic diameter, μ is a fluid viscosity, fᵤ is a friction factor based on v, Reᵥ is a Reynolds number based on v, ΔP is a pressure difference, L is a porous medium length, u is an apparent flow velocity, φ is porosity, T is hydraulic tortuosity, fᵤ is a friction factor based on u, Reᵤ is a Reynolds number based on u, k is permeability, C_{K} is a Kozeny constant, S_{S} is a specific surface area, ξ is a friction ratio, and ρ is a fluid density.

Therefore, the definitions of permeability, microscopic friction factor (fᵥ), and Reynolds number (Reᵥ) are deduced, as summarized in Equation 5(b). The permeability definition is equal to Kozeny's permeability in Equation 3(b). Consequently, we confirmed that the definitions of Kozeny's tortuosity and permeability are physically valid from both Equations 4 and 5.

Hence, the repeated incorporation of the tortuosity concept into Equation 5(a) in the derivation of the Kozeny-Carman equation is unnecessary. In the derivation of Equation 5(a), the mass conservation relation in the form of the tortuosity-velocity definition (v=u/φT), was already introduced to all the velocity terms in Equation 1; thus, there is no need to repeatedly incorporate the tortuosity concept into the superficial velocity term in Equation 5(a). If tortuosity is again applied to Equation 5(a), as Carman suggested, the resulting tortuosity-velocity relation (T²=u/φv=(L/Lₑ)²) evidently violates the mass conservation relation (T=u/φv=L/Lₑ), whereas, the product of microscopic friction factor (fᵥ) and Reynolds number (Reᵥ) results in Equation 5(a), honoring the mass conservation and Darcy laws.

Finally, the frictional losses of each material may be further altered owing to individually distinct pore structures, cross-sectional shapes, and roughness. However, the frictional flow losses (pressure drops) should be represented by the friction constant (fᵥReᵥ=32C_{K}), which was originally described to correlate to different friction effects, rather than the tortuosity-velocity relation. Again, the Kozeny constant (C_{K}) was already adopted in Equation 3(b); as a result, it is pointless to further incorporate the tortuosity concept after including the Kozeny constant (in which overall frictional flow effects were already included). Therefore, the tortuosity correlation between path lengths and flow velocities must be defined only using the mass conservation law, whereas the frictional losses must be correlated to the Kozeny constant in the momentum equation, as expressed in Equations 4 and 5.

Nevertheless, the interstitial flow velocity (v) in Equation 5(a) may be directly correlated to the path length (Lₑ) as Carman attempted it in the derivation of the Kozeny-Carman equation. Moreover, the equivalent flow model introduced in Equations 4 and 5 may be considered as either noncircular or circular pipes. In case of circular section, the internal flow velocity of the circular pipe model, which is defined using each fixed (isotropic) hydraulic diameter of porous medium under the same pressure drop condition, cannot be equal to the true interstitial velocity through heterogeneous porous media; thus, the equivalent flow model in Equations 4 and 5 cannot be defined assuming a circular pipe. Considering noncircular section, the sectional area cannot be determined using the formula of circle area (πDₕ²/4). Therefore, the noncircular pipe model must be re-transformed to an equivalent cylinder model having the same interstitial velocity (i.e., path length (Lₑ)) and pressure difference; this naturally requires the other equivalent diameter (distinct from the hydraulic diameter).

### Modification of the Kozeny-Carman Equation

In the present invention, the Kozeny relation of Equation 3 is theoretically verified and Carman relation of Equation 2 is theoretically and experimentally verified to modify the Kozeny-Carman Equation, thereby presenting Equations 6 and 7.

Specifically, Equation 5(a) is redefined as a function of the real flow path length (Lₑ) adopting an equivalent cylindrical flow model, as shown in Equation 6(a).

$$〈 Equation 6 〉$$

$$\begin{matrix}v = - \frac{2 {D}_{h}^{2}}{μ \cdot {f}_{v} {Re}_{v}} \frac{Δ P}{L} & ( a ) \\ where & \\ {f}_{e} = \frac{2 {D}_{e}}{{ρ}^{{v}^{2}}} \frac{Δ P}{{L}_{e}} & \\ ∵ Re = \frac{ρ v {D}_{e}}{μ} , & \\ & \\ {f}_{e} {Re}_{e} = 64 & \\ ∴ {D}_{e} = \frac{{D}_{h}}{{( T \cdot ξ )}^{0.5}} & ( b ) \\ where & \\ ξ = \frac{{f}_{v} {Re}_{v}}{64} = \frac{{f}_{v} {Re}_{v}}{{f}_{e} {Re}_{e}} = \frac{{C}_{K}}{2} & \\ ∴ k = \frac{ϕ \cdot {D}_{e}^{2} \cdot {T}^{2}}{32} & ( c ) \\ ∴ v = - \frac{2 {D}_{e}^{2}}{μ \cdot {f}_{e} {Re}_{e}} \frac{Δ P}{L} \cdot T = \frac{u}{∅ T} & \\ ∴ k = \frac{2 {D}_{e}^{2}}{{f}_{e} {Re}_{e}} \cdot ∅ {T}^{2} & \\ or & \\ k = \frac{∅ \cdot }{32} & ( d ) \\ where & \\ = {D}_{e} \cdot T = {D}_{h} \cdot {( \frac{T}{ξ} )}^{\frac{1}{2}} & \end{matrix}$$

In Equation 6, v is an interstitial flow velocity, Dₑ is an effective diameter, μ is a fluid viscosity, fₑ is an effective friction factor, Reₑ is an effective Reynolds number, ΔP is a pressure difference, Lₑ is an actual pore flow length, ρ is a fluid density, Dₕ is a hydraulic diameter, T is hydraulic tortuosity, ξ is a friction ratio, fᵤ is a friction factor based on v, Reᵥ is a Reynolds number based on v, C_{K} is a Kozeny constant, k is permeability, φ is porosity, L is a porous medium length, u is an apparent flow velocity, and [symbol] is a superficial effective diameter.

It is supposed to also have identical frictional flow aspects (u, v, ΔP) to the target porous media, as shown in Equation 6(a). Note that the effective diameter (Dₑ) of porous media is newly defined because of the revised path length from “L” to “Lₑ” in the pressure gradient term; the hydraulic diameter in Equation 5(a) must be modified for the identical interstitial velocity (v) and pressure difference (ΔP) conditions due to the revised path length. Again, the hydraulic diameter (Dₑ) cannot be the diameter of the truly equivalent cylinder model since the pore path shapes of actual granular beds cannot be circular cylindrical, and their structures are uneven and tortuous. In conventional viscous internal flow theory, the effective diameter is defined as the equivalent diameter of noncircular conduits to be properly integrated into viscous pipe flow theories (qualitatively equivalent) (White, 2001), based on the hydraulic diameter (Dₕ), which may be determined only using basic geometric relation (quantitatively equivalent) of noncircular conduits.

Moreover, the effective friction factor (fₑ) and effective Reynolds number (Reₑ) may be defined based on the effective diameter (Dₑ) of the equivalent cylinder model; therefore, the effective friction constant (fₑReₑ) may finally be equivalent to that of a circular cylinder: fₑReₑ=64; whereas, the friction constant (fᵥReᵥ) defined based on the hydraulic diameter cannot assure it because of the non-cylindrical paths of actual granular packs.

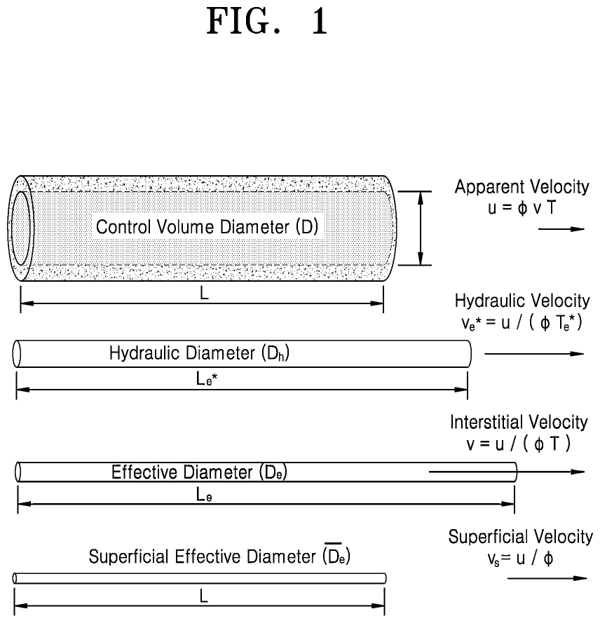

Consequently, the definition of the effective diameter (Dₑ) of porous media is presented in Equation 6(b), by combining Equations 5(a) and 6(a) for identical interstitial flow velocity and pressure difference conditions. Equation 6(b) is slightly different from that of normal conduits owing to the variable pore flow paths (tortuosity) in each flow direction within the identical porous medium. Furthermore, the permeability (Kozeny-Carman equation) is redefined in Equation 6(c) using the effective diameter. In addition, the superficial effective diameter ( [symbol] ) is defined in Equation 6(d) for further expansions, based on the superficial velocity (vₛ≠v) as another type of effective diameter with cylindrical friction constant and the same pressure difference along the medium length (L) (refer to FIG. 1).

In addition, we may define the effective tortuosity (Tₑ*), which is coupled with the hydraulic diameter (Dₕ), similar to how the effective diameter (Dₑ) is linked to the hydraulic tortuosity (T). Again, the effective diameter was defined as the diameter of the equivalent cylinder, which was assumed to have identical frictional flow features and flow path length (tortuosity). Similarly, the effective tortuosity may be described as the tortuosity (flow path length) of the other reference cylindrical flow model, which is assumed to have like frictional loss features (u, vₑ*≠v, ΔP), however, based on the hydraulic diameter. Then, under the identical pressure difference condition, the “special hydraulic cylinder model” denoted by a superscripted *, where the effective diameter becomes the same as the hydraulic diameter (Dₑ*=Dₕ at ΔP*=ΔP), is asserted. Herein, note again that the special interstitial velocity (vₑ*) cannot be equal to the actual interstitial velocity (v) (because of the noncircular pore paths), vₑ*≠v. Therefore, the flow path length (Lₑ*) of the special hydraulic cylinder model differs from the flow path length (Lₑ) of the truly equivalent cylindrical flow model: Tₑ*=L/Lₑ*≠T.

As a result, the effective tortuosity (Tₑ*) is defined in Equation 7 for the special interstitial velocity (vₑ*≠v) passing through the special cylinder model under identical pressure difference conditions (ΔP*=ΔP).

$$〈 Equation 7 〉$$

$$\begin{matrix}{v}_{e}^{*} = - \frac{2 {D}_{e}^{2}}{μ \cdot {f}_{e} {Re}_{e}} \frac{Δ P}{{L}_{e}^{*}} = - \frac{{D}_{h}^{2}}{32 μ} \frac{Δ P}{{L}_{e}^{*}} = \frac{u}{∅ {T}_{e}^{*}} & ( a ) \\ where & \\ {D}_{e} = {D}_{h} \cdot Δ {P}^{*} = Δ P , & \\ T \neq {T}_{e}^{*} = \frac{L}{{L}_{e}^{*}} & \\ ∴ = {D}_{e} \cdot T = {D}_{h} \cdot {T}_{e}^{*} & \\ ∵ \frac{{v}_{s}}{{v}_{e}^{*}} = \frac{{D}_{h}^{2} \cdot {T}_{e}^{*}}{} = {T}_{e}^{*} & \\ where & \\ {v}_{s} = - \frac{32 μ}{} \frac{Δ P}{L} = \frac{u}{∅} & \\ & \\ {v}_{e}^{*} \neq v & \\ ∴ k = \frac{∅ \cdot {D}_{h}^{2} \cdot {T}_{e}^{* 2}}{32} & ( b ) \\ and & \\ k = \frac{{∅}^{3}}{2} {( \frac{{T}_{e}^{*}}{{S}_{s}} )}^{2} & \\ where & \\ {T}_{e}^{*} = \frac{{D}_{e}}{{D}_{h}} \cdot T = {( \frac{T}{ξ} )}^{0.5} = \frac{u}{∅ {v}_{e}^{*}} & \end{matrix}$$

In Equation 7, vₑ* is an interstitial velocity of the special hydraulic cylinder model, Dₑ is an effective diameter, μ is a fluid viscosity, fₑ is an effective friction factor, Reₑ is an effective Reynolds number, ΔP is a pressure difference, Lₑ* is a flow path length of the special hydraulic cylinder model, Dₕ is a hydraulic diameter, u is an apparent flow velocity, φ is porosity, Tₑ* is effective tortuosity of the special hydraulic cylinder model, ΔP* is a pressure difference of the special hydraulic cylinder model, D̅ₑ̅ is a superficial effective diameter, T is hydraulic tortuosity, vₛ is a superficial flow velocity, L is a porous medium length, k is permeability, S_{S} is a specific surface area, and is a friction ratio.

FIG. 1 is a schematic diagram showing hydraulic variables and effective variables based on a cylindrical medium in the method of predicting permeability of porous material based on anisotropic flow model, according to an embodiment of the present invention.

Referring to FIG. 1, the diameter, length, and flow velocity of the pores in the porous medium are illustrated. For the porous medium, a length (L) and an apparent flow velocity (u) with respect to a diameter of a control volume (D) are shown. A flow path length (Lₑ*) of the special cylinder model and a hydraulic flow velocity (vₑ*) of the special cylinder model with respect to a hydraulic diameter (Dₕ) are shown. An actual pore flow length (Lₑ) and an interstitial flow velocity (v) with respect to a true effective diameter (Dₑ) are shown. A porous medium length (L) and a superficial flow velocity (vₛ) with respect to a superficial (apparent) effective diameter ( [symbol] ) are shown.

The key variables of each flow model are compared with those of the original porous medium, as shown in FIG. 1.

In Equation 7(a), the interstitial velocity relation in Equation 6(a) was reintroduced to the special cylinder model, and then both special and superficial flow velocities (vₑ* and vₛ) were correlated to their respective definitions for identical apparent flow velocity (u) and pressure difference (ΔP) conditions. Therefore, the effective and superficial diameters were correlated with the hydraulic diameter using the effective tortuosity, as presented in Equation 7(a). Moreover, the permeability definition in Equation 6(c) was re-expressed in Equation 7(b) as a function of the effective tortuosity (Tₑ*).

When comparing the new permeability definitions specified in Equations 6(c) and 7(b) to Carman's definition (k_{C}) in Equation 2(b), the main difference in Equation 6(c) is that the hydraulic diameter (Dₕ) in Carman's definition is replaced with the effective diameter (Dₑ), and in Equation 7(b) is that the hydraulic tortuosity (T) in Carman's definition is replaced with the effective tortuosity (Tₑ*). Furthermore, the Kozeny constant (C_{K}) from Equation 2(b) is eliminated in both Equations 6(c) and 7(b); and implicitly included in each effective variable.

It implies that the definition of the Kozeny constant should be modified from “C_{K}” to “C_{K-C}” in the Kozeny-Carman equation. The microscopic Darcy friction factor

$${f}_{v} = \frac{2 {D}_{h}}{{ρ}^{{v}^{2}}} \frac{Δ P}{L}$$

in Equation 5(b) must be revised to

$${f}_{{v}_{K - C}} = \frac{2 {D}_{h}}{{ρ}^{{v}^{2}}} \frac{Δ P}{L} \cdot T$$

to agree with the relation, fᵥReᵥ=fᵤReᵤ φT², imposed from the correlation between Equations 1 and 2,

$$k = \frac{2 {D}_{h}^{2}}{{f}_{u} {Re}_{u}} = \frac{{D}_{h}^{2} \cdot ∅ {T}^{2}}{16 {C}_{K}} = \frac{2 {D}_{h}^{2} \cdot ∅ {T}^{2}}{{f}_{v} {Re}_{v}} .$$

Accordingly, the Kozeny constant must be redefined as C_{K-C}=2ξ_{K-C}=f_{υ}_{_{K-C}} Re_{υ}/32=2ξ·T=C_{K}·T in the Kozeny-Carman equation.

However, the revision (C_{K-C}=C_{K} T) in Equation 2(b) results in an identical definition of Kozeny's permeability in Equation 3(b). In other side, the modified Kozeny constant of the special hydraulic cylinder model may be then equal to that of circular cylinder (i.e., f_{υ*}_{_{K-C}}Re_{υ*}=64) as Carman assumed (C_{K-C}≈2); however, note that the special internal flow velocity (v*) is not the true interstitial flow velocity (v) passing through the original porous medium, as discussed in Equation 7;

$$T \neq {T}_{e}^{*} = \frac{u}{∅ {v}_{e}^{*}} .$$

Therefore, we reconfirm that Carman's tortuosity definition is unreasonable, and then the Kozeny-Carman equation must be modified to either Equation 6 or 7; it would rather be transformed to Equation 6 based on the truly equivalent flow model (Dₑ, T, fₑ, and Reₑ).

Finally, it is required to verify whether the effective diameter presented in Equation 6(b) is the truly equivalent diameter of the target porous media. Actually, infinite numbers of cylindrical flow models may be defined to have the identical pressure difference (or internal flow velocities); using the individual pairs of diameter and path length (tortuosity). However, the truly equivalent cylindrical flow model only produces both the identical interstitial velocity and pressure difference to those of the original porous medium, and then the frictional flow variables may be consistently defined based on it. Moreover, Carman's tortuosity, defined along with the hydraulic diameter in the Kozeny-Carman equation, needs to be examined whether it is reasonably correlated with the path length of the truly equivalent cylinder model; i.e., whether the interstitial velocity of the special hydraulic cylinder model, defined based on the hydraulic diameter, is equal to the actual internal flow velocity through the target porous medium; v*=v. Furthermore, Equations 6 and 7 were obtained after assuming that hydraulic diameter cannot be identical to the effective diameter in actual porous media. Therefore, the disparity between the hydraulic tortuosity and the reciprocal of the friction constant ratio should be verified; because

$${D}_{e} = \frac{{D}_{h}}{{( T \cdot ξ )}^{0.5}} = {D}_{h} ,$$

### if T=1/ξ.

Accordingly, the pore-scale simulation (PSS) analyses targeting the 5-sorts of 25-series porous medium models in a wide range of porosity and permeability are performed to confirm the validity of the effective variables and modified relations.

### Validation Using the Pore-Scale Simulation

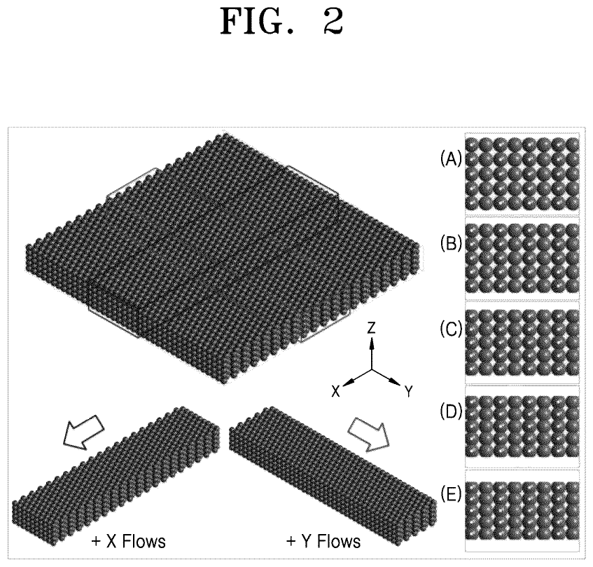

FIG. 2 shows a simple porous medium model for pore-scale simulation in the method of predicting permeability of porous material based on anisotropic flow model, according to an embodiment of the present invention.

Referring to FIG. 2, the simple porous medium model for pore-scale simulation is shown. The simple porous medium model is assumed to have a simple structural shape consisting of a group of parallel plates. The simple porous medium model is constructed using microscale grid lattices and presents a multilayered three-dimensional (3D) shape having five layers filled with identical spherical beads in staggering arrays. The above structure originally had a length×width×hole (height) of 4×4×0.5 mm. The simple porous medium model has pores classified into five types.

The simple porous medium model has a shape in which grains (beads) of the same size are arranged, for example, 1975 spherical beads with a uniform diameter of 0.102 mm are arranged for each flow direction. The beads (i.e., grains) may have a radius in the range of 45 μm to 55 μm. The original diameter of the beads is excluding the portion cut by the plate or the portion overlapped by adjacent beads. That is, the beads may be represented by being cut by the plates and the overlapping of adjacent beads. They are positioned between the two plates, mimicking the staggered distribution of supports within the crack.

The geometric structure of a “base model” of the simple porous medium model is shown in the top left portion. The geometric comparison of the aperture reduction in the X-Z plane for the five models is shown in the right portion. (A) is a “thickest model” having an initial crack height (h) of 0.5 mm, (B) is a “thick model” having a crack height of 0.475 mm, (C) is a “base model” having a crack height of 0.45 mm, (D) is a “thin model” having a crack height of 0.425 mm, and (E) is a “thinnest model” having a crack height of 0.4 mm. Each of the models has five multilayers. In each model, the beads are assumed to simply and homogeneously shrink into adjacent beads or walls as the crack height changes. The simple porous medium model may have the crack height in the range of 0.4 mm to 0.5 mm and the porosity in the range of 36% to 47.5%.

Two types of the simple porous medium model for each flow direction are shown in the lower left portion. In the simple porous medium model shown in the upper left portion, the blue area is the X-direction flow model in the blue direction, and the red area is the Y-direction flow model in the red direction. A total of 1,975 spherical beads with a uniform diameter of 0.102 mm were used for each flow direction. The original diameter of the beads is excluding the portion cut by the plate or the portion overlapped by adjacent beads. Here, two perpendicular flow directions (X and Y) are introduced to the simple porous medium model, respectively, to evaluate various flow shapes related to the directional pore path due to the influence of hydraulic tortuosity.

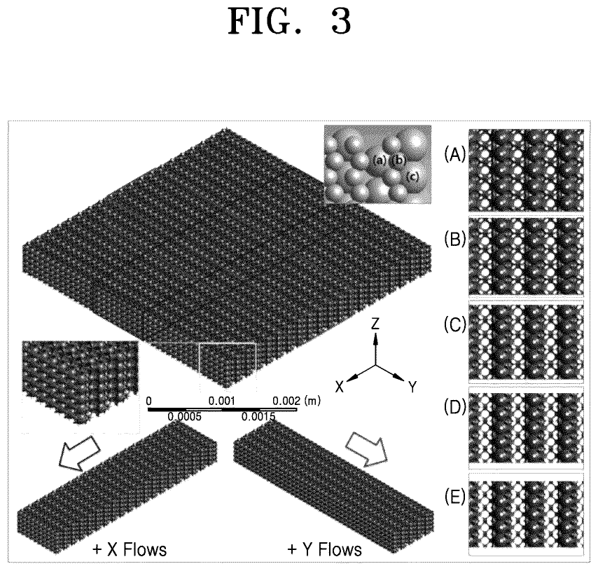

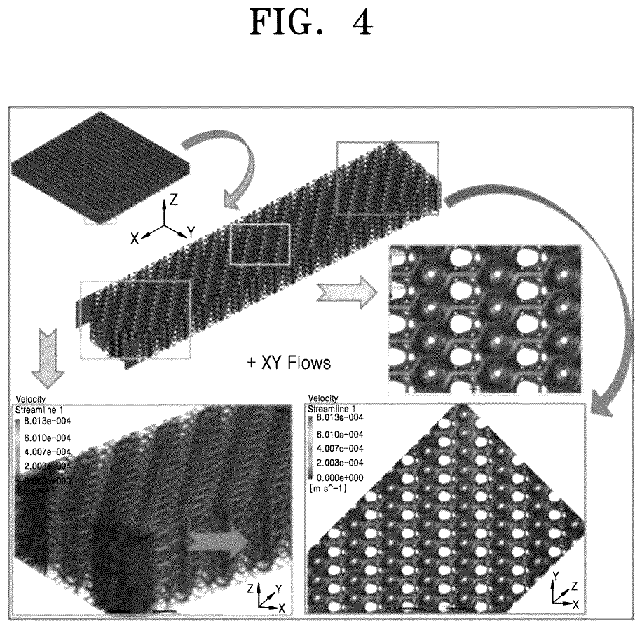

FIGS. 3 and 4 shows a complex porous medium model for pore-scale simulation in the method of predicting permeability of porous material based on anisotropic flow model, according to an embodiment of the present invention.

Referring to FIG. 3, the complex porous medium model for pore-scale simulation is illustrated. The complex porous medium model is constructed using fine grid lattices, and a multilayered three-dimensional (3D) shape having five layers in staggered arrangements is shown. The complex porous medium model has a shape in which grains of different sizes are arranged, and the grains of different sizes may be arranged in a staggered manner. The grains may have a radius in the range of 30 μm to 55 μm.

For example, the complex porous medium model may be configured to include beads of three different sizes, thereby representing more dense and realistic models. This complex porous medium model is set up to extensively analyze cases that exhibit a wide range of porosity from 13.4% to 47.4% and permeability from 0.0073 Darcy to 18.3 Darcy.

The geometric structure of a “base model” of the complex porous medium model is shown in the top left portion. The three different sizes of the 28,160 microbeads are shown without the others. The geometric comparison of the aperture reduction in the X-Z plane for the five models is shown in the right portion. (A) is a “thickest model” having an initial crack height (h) of 0.5 mm, (B) is a “thick model” having a crack height of 0.475 mm, (C) is a “base model” having a crack height of 0.45 mm, (D) is a “thin model” having a crack height of 0.425 mm, and (E) is a “thinnest model” having a crack height of 0.4 mm. Each of the models has five multilayers. The complex porous medium model may have the crack height in the range of 0.4 mm to 0.5 mm, and the porosity in the range of 13.3% to 22.6%.

An enlarged view to better illustrate the complex pore structure is shown in the left middle portion. Three bead sizes with staggered arrangements are shown in the upper left portion, with (a) beads having 51 μm radius, (b) beads having 30 μm radius, and (c) beads having 55 μm radius.

Two types of complex porous medium models for each flow direction are shown in the lower left portion. In the complex porous medium model shown in the upper left portion, the blue area having a dimension of 4×1×0.5 mm is the X-direction flow model in the blue direction, and the red area having a dimension of 4×1×0.5 mm is the Y-direction flow model in the red direction. Here, two perpendicular flow directions (X and Y) are introduced into the complex porous medium model, respectively, to evaluate various flow shapes related to the directional pore paths due to the influence of hydraulic tortuosity.

Referring to FIG. 4, To test the asymmetric and anisotropic structures, diagonal flow was defined. Specifically, the green region was obtained from the thickest model, and the XY-direction flow model is shown, which is expanded from 400 μm to 500 μm to have dimensions of 5×1×0.5 mm. For this purpose, each grid boundary was extended and moved to have a non-periodic and biased pore distribution. In summary, a total of 15 complex PSS models were set up to examine a wide range of porosity, tortuosity, permeability, and anisotropic structures. In addition, streamline distributions around the inlet, center, and outlet are shown to further illustrate the complex and anisotropic pore flow.

Referring to FIGS. 2 through 4, since the simple porous medium model has five types each for the X-direction and the Y-direction to become 10 cases, and the complex porous medium model has five types each for the X-direction, the Y-direction and the XY-direction to become 15 cases, total 25 cases of pore-scale simulation models may be constructed.

Hereinafter, more detailed geometrical features, numerical settings, and evaluation of the simple porous medium model are described.

In the simple porous medium model, an original multilayer 3D porous medium is assumed as a simple structural shape. A group of plates has the dimensions of 4-mm-length×4-mm-width×0.5-mm-height and is filled with 5 layers of identical spherical beads. From the original model, the flow direction is divided into X-direction and Y-direction, and two types are set.

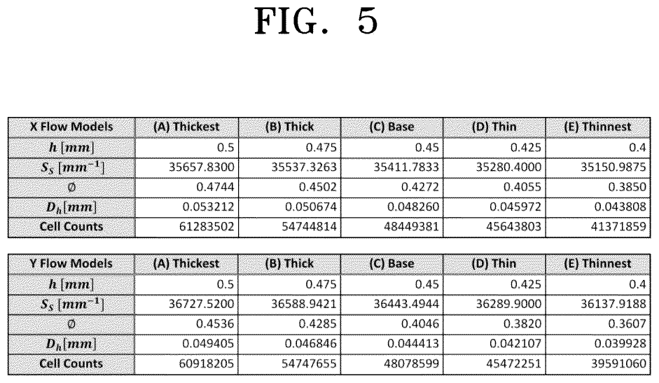

FIG. 5 is a table showing key geometric shape information for performing the pore-scale simulation of the simple porous medium model in the method of predicting permeability of porous material based on anisotropic flow model, according to an embodiment of the present invention.

Referring to FIG. 5, crack height (h), specific surface area (S_{S}), porosity (φ), hydraulic diameter (Dₕ), and cell count of the simple porous medium model are shown.

The “thickest model” in (A) is defined in the original model to have geometric dimensions of 4-mm-length×1-mm-width×0.5-mm-height for each direction. Similarly, the “thick model” in (B) has a height of 0.475 mm, and the “base model” in (C) has a height of 0.45 mm. Since the hole shrinkage occurs due to stress variation in the vertical direction, it is assumed that beads in each medium is simply and uniformly inserted into the adjacent bead and wall. The “thin model” in (D) has a height of 0.425 mm, and the “thinnest model” in (E) has a height of 0.4 mm. The final fine grid size of the unstructured tetrahedral grid systems of each model is verified using different grid resolutions.

The fluid is assumed to be pure liquid water, with a density of 998.2 kg/m³ and a viscosity of 0.001003 kg/ms. The solid walls or surfaces of all models are assumed to be completely smooth and isothermal. That is, the grains may have smooth surfaces and isothermal.

The apparent velocity (u) is 0.1 mm/s, and is set perpendicular to the two vertical injection ports in the Y-Z plane and the X-Z plane, and aligned with respect to the respective flow directions of X and Y as shown in FIG. 2. Here, in order to confirm that the 0.1 mm/s condition satisfies the Darcy flow rule with other conditions, a 0.01 mm/s condition is additionally performed.

In summary, pore-scale simulations are performed for a total of 10 simple porous medium models under steady-state flow conditions using commercial Ansys-fluent software of Ansys. The 10 cases consist of five different bead arrangements, and two different directions. Here, in order to verify whether the 0.1 mm/s condition satisfies the different flow rules, additional simulations was performed for the 0.01 mm/s condition.

The geometric and flow conditions other than those mentioned above are the same in all cases. The basic convergence criterion is set to a residual less than 10⁻⁸ in all equations. The second-order upwind scheme and the SIMPLE method are applied to spatial discretization and pressure-velocity coupling, respectively. To overcome convergence and accuracy issues, different grid resolutions were tried to determine the final number of fine cells for each simple porous medium model.

Here, the applied fine grid system, numerical settings, and flow conditions are verified through pore-scale simulations performed first using the “plate model”. The plate model is composed of horizontally parallel plates with the dimensions of 4-mm-length×1-mm-width. It is identical to the simple porous medium model of the original type, but the height is 10 times smaller in order to form the Reynolds numbers of the plate model for the targeted pore-scale simulations in the same order. That is, the height is 0.05 mm and the aspect ratio is 0.0125.

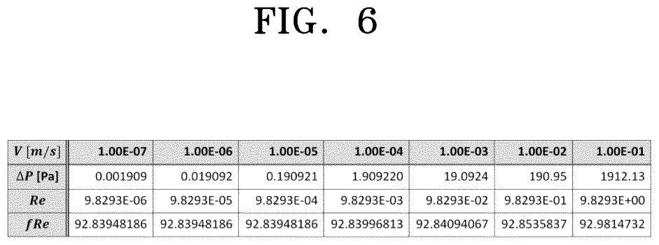

FIG. 6 is a table showing key pore-scale simulation results of the simple porous medium model in the method of predicting permeability of porous material based on anisotropic flow model, according to an embodiment of the present invention.

Referring to FIG. 6, Key geometric information and grid information for the main pore-scale simulation results of 10 cases of the simple porous medium models are presented. In addition, flow velocity (v), pressure difference (ΔP), Reynolds number (Re), and friction constant (fRe) are shown. The numerical validity of the pore-scale simulation results of the simple porous medium model is examined by comparing the pressure difference (pressure drop) derived from the Hagen-Poiseuille equation with the pressure difference of the pore-scale simulation results under laminar flow conditions. According to the linear regression analysis of the friction constant (fRe) according to the changes in the aspect ratio of the rectangular duct, when the friction constant (fRe) value of the flat plate model is about 92.4, the difference by comparison is about 0.5%. The Knudsen number (Kn) was examined in the range of 0.000005 to 0.00025, depending on the hydraulic diameter and average cell size of the “thickest model”. Since Kn<<0.1, the conventional method of computer-aided fluid dynamics was applied to pore-scale simulation models (Bird, 1994; Nicolas, 2006).

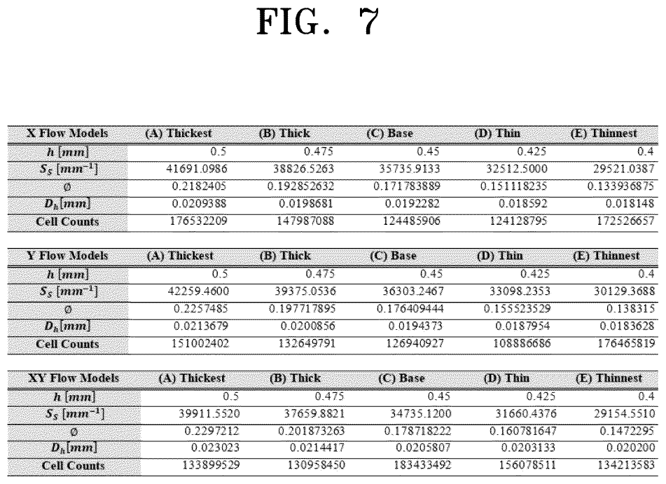

FIG. 7 is a table showing key geometric shape information for performing the pore-scale simulation of the complex porous medium model in the method of predicting permeability of porous material based on anisotropic flow model, according to an embodiment of the present invention.

Referring to FIG. 7, crack height (h), specific surface area (S_{S}), porosity (φ), hydraulic diameter (Dₕ), and cell count of the complex porous medium model are shown.

Referring to FIG. 3, in the complex porous medium model, the parallel plates are filled with five layers of three different sized spherical beads in staggered arrangements for five different pores. Here, similar to the simple porous medium model, two directional flow conditions (X and Y) are defined.

For the “Base” model, after examining the Darcy flow rule by combining the velocity condition of 0.001 mm/s for each flow direction, the input velocity is set to 0.01 mm/s. The basic convergence criterion is set to a residual less than 10⁻⁷ in all mathematical equations. Other flow conditions and settings of the pore-scale simulation for the complex porous medium model is set the same as those for the simple porous medium model. The grid resolution, such as minimum surface area, maximum surface area and grid volume, is reduced and therefore changed for several models.

The pore-scale simulation of the complex porous medium model was used to analyze the cases showing a wide range of porosity from 13.4% to 47.4% and permeability from 0.0073 Darcy to 18.3 Darcy. In addition, by applying two vertical flow direction conditions (X-direction and Y-direction) to both the simple and complex porous medium models, the anisotropic flow characteristics according to the directional pore path were evaluated, and specifically, the effect of tortuosity was evaluated. In addition, the grid boundary was moved and extended to show aperiodic and biased distributions, and five diagonal directions, i.e., XY-direction, flow cases of the complex porous medium models were defined to examine the asymmetric and anisotropic structures.

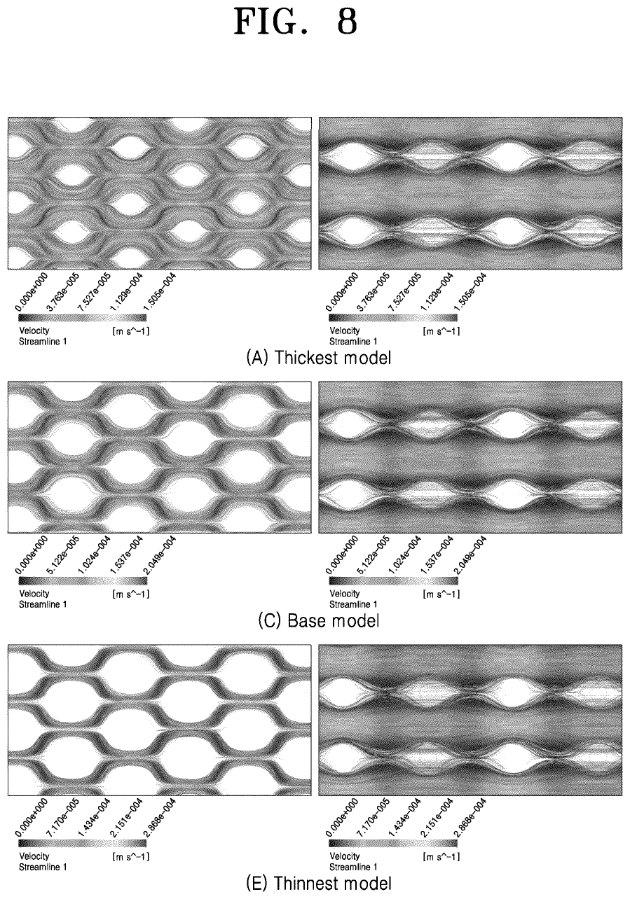

FIGS. 8 through 10 show streamline distributions derived from the pore-scale simulation results in the method of predicting permeability of porous material based on anisotropic flow model, according to an embodiment of the present invention.

Referring to FIG. 8, as a result of pore-scale simulation for the simple porous medium model, streamline distributions according to the flow conditions in the X direction are shown for (A) the “Thickest model”, (C) the “Base model”, and (E) the “Thinnest model”. The left streamline distribution is the central part of the X-Y plane, and the right streamline distribution is the central part of the X-Z plane.

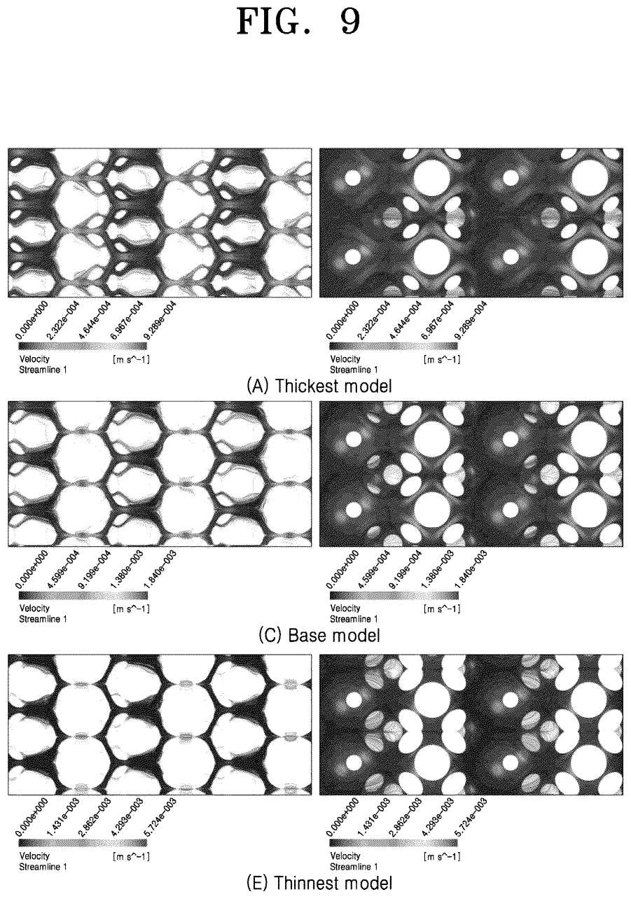

Referring to FIG. 9, as a result of pore-scale simulation for the complex porous medium model, streamline distributions according to the flow conditions in the X direction are shown for (A) the “Thickest model”, (C) the “Base model”, and (E) the “Thinnest model”. The left streamline distribution is the central part of the X-Y plane, and the right streamline distribution is the central part of the X-Z plane.

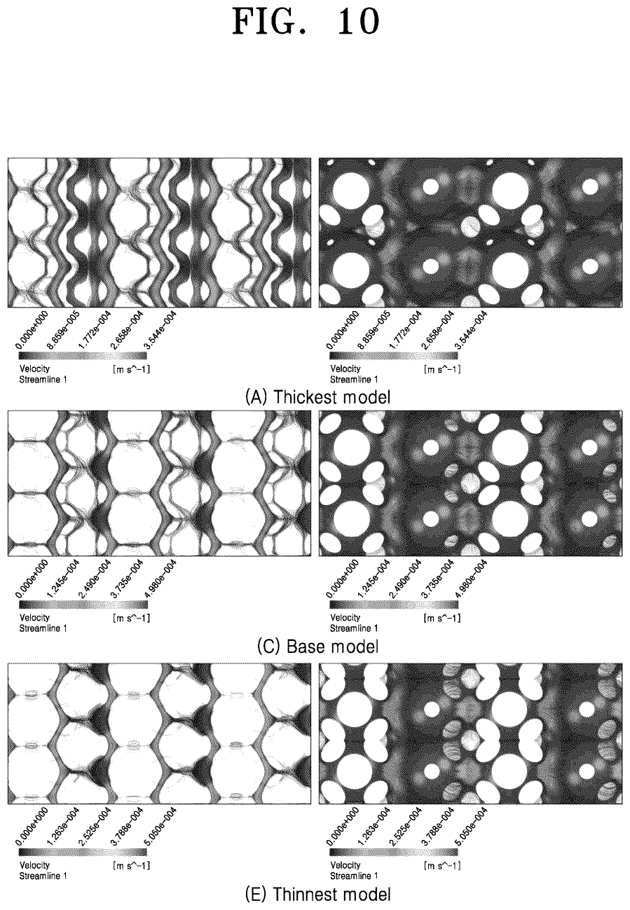

Referring to FIG. 10, as a result of pore-scale simulation for the complex porous medium model, streamline distributions according to the flow conditions in the Y direction are shown for (A) the “Thickest model”, (C) the “Base model”, and (E) the “Thinnest model”. The left streamline distribution is the central part of the X-Y plane, and the right streamline distribution is the central part of the X-Z plane.

Referring to FIGS. 8 through 10, the overall flow distribution and deformation of each model are shown when the porosity reduction occurs. It may be seen that the flow patterns and path structures are maintained in the simple porous medium model regardless of the aperture change. On the other hand, the flow structures show significant changes in the complex porous medium model. These changes are due to the changes in the special surface area caused by the narrow and closed paths and the twisted paths of the flow structures. Compared to the pore-scale simulation results of the simple porous medium model, the pore-scale simulation results of the complex porous medium model show that more friction occurs and thus the flow has a complex shape. This result is analyzed to be because the flow path in the complex porous medium model is configured to be narrow and twisted repeatedly.

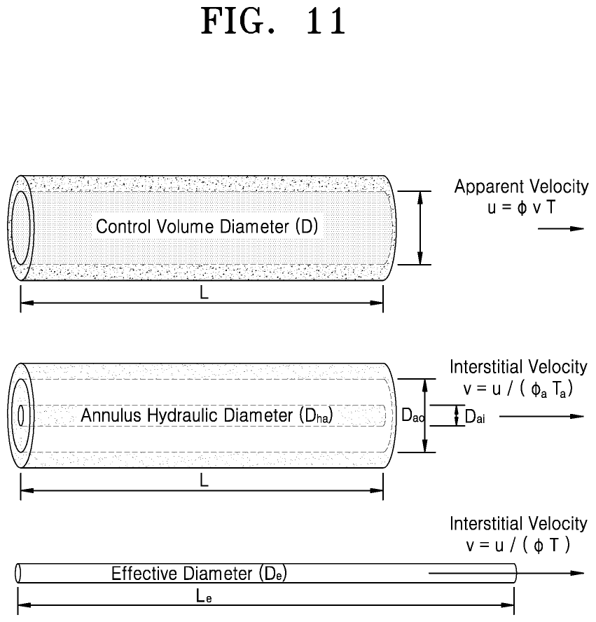

FIG. 11 show a concentric annulus flow model in the method of predicting permeability of porous material based on anisotropic flow model, according to an embodiment of the present invention.

Referring to FIG. 11, a geometric comparison is made between the cylindrical flow model described using FIG. 1 and the concentric annulus flow model. In the concentric annulus flow model, the flow path is indicated in white, and the solid body is indicated in gray. In order to predict the effective diameter and hydraulic tortuosity (interstitial flow velocity), a concentric annulus flow model having the same length for a cylindrical porous medium is introduced. Here, the extended pore flow length (surface area) of the porous medium is assumed to be proportional to the increased surface areas of the inner and outer cylinders of the concentric tube flow model.

That is, the outer diameter (Dₐₒ) and inner diameter (Dₐᵢ) of each concentric annulus flow model are set to have the same superficial flow velocity (u), porosity, solid surface area, and pressure difference (pressure drop) under a special hydraulic condition (Dₑ=Dₕ, a concept introduced in the development of Equation 7 and distinguished by a superscript *). Here, the defined equivalent concentric annulus flow model naturally has a gap velocity (vₐ*) different from the actual internal velocity (v). In other words, each equivalent concentric annulus flow model may be defined as having the same pressure drop as that of each porous medium under special hydraulic conditions ((Dₑ=Dₕ, i.e., ζ=1/ξₐ^{0.5}, see Equation 5). Therefore, the hydraulic diameter (Dₕₐ*) of the equivalent concentric annulus flow model satisfying the special hydraulic conditions may be easily estimated by determining the size factor (ζ) for the outer diameter and the clogging factor (η) for the inner diameter defined in Equation 8(a). These may be determined using Equation 8(d) and Equation 8(e), or simply by trial and error. For the special concentric annulus flow models used in the present invention, these factors may be defined even when the internal gap velocity cannot be measured using the effective tortuosity correlation (T*=(1−η*)²=Tₑ) for the given conditions (known u and ΔP). Here, the hydraulic diameter (Dₕₐ) and friction constant (ξₐ) of the concentric annulus flow model may be determined by applying the general theory for the concentric annulus cylinder structure, and are shown in Equation 8(a) and Equation 8(b) (White, 2001).

$$〈 Equation 8 〉$$

$$\begin{matrix}{D}_{{h}_{a}} = {D}_{{a}_{0}} - {D}_{{a}_{i}} & ( a ) \\ where & \\ {D}_{{a}_{0}} = ξ \cdot {D}_{h} & \\ and & \\ {D}_{{a}_{i}} = η \cdot {D}_{{a}_{0}} = ξ η \cdot {D}_{h} & \\ {ξ}_{a} = \frac{{( 1 - η )}^{2}}{( 1 + {η}^{2} ) + \frac{( 1 - {η}^{2} )}{ln ( η )}} & ( b ) \\ where & \\ {f}_{a} {Re}_{a} = {( {f}_{u} {Re}_{u} )}_{{D}_{{a}_{0}}} \cdot ∅ {T}^{2} = 64 \cdot {ξ}_{a} & \\ {T}_{a} = \frac{L}{{L}_{a}} = \frac{L}{L + Δ L} = \frac{u}{v \cdot {∅}_{a}} = \frac{( 1 - η )}{( 1 + η )} & ( c ) \\ ∴ Δ L = \frac{π \cdot ( {D}_{{a}_{0}} + {D}_{{a}_{i}} - {D}_{{h}_{a}} ) \cdot L}{π \cdot {D}_{{h}_{a}}} = \frac{2 η \cdot L}{( 1 - η )} & \\ \frac{{∅}_{a}}{∅} = \frac{( {D}_{{a}_{0}}^{2} - {D}_{{a}_{i}}^{2} )}{{D}_{{a}_{0}}^{2}} = ( 1 - {η}^{2} ) & ( d ) \\ and & \\ T = \frac{u}{∅ v} = {T}_{a} \cdot \frac{{∅}_{a}}{∅} = ( 1 - {η}^{2} ) & \\ {D}_{e} = \frac{ξ \cdot {D}_{h}}{{ξ}_{a}^{0.5}} & ( e ) \\ ∵ {D}_{e} = \frac{{D}_{{h}_{a}}}{{( T \cdot {ξ}_{α} )}^{0.5}} & \\ and & \\ v = - \frac{2 {D}_{{h}_{a}}^{2}}{μ \cdot {f}_{a} {Re}_{a}} \frac{Δ {P}^{*}}{L} & \end{matrix}$$

Then, as shown in Equation 8(c), the active tortuosity (Tₐ, equivalent tortuosity) may be geometrically determined by inversely transforming the total surface area of each equivalent concentric annulus cylinder structure into the path length (Lₐ=L+ΔL) of the equivalent hydraulic cylinder (defined as Dₕₐ). Also, as shown in Equation 8(d), the active porosity ratio (φₐ/φ) may be defined as a function of the clogging factor. Here, the hydraulic tortuosity may be defined as a function of the clogging factor. Note that when defining a special hydraulic concentric annulus flow model, the effective tortuosity may be T*=(1−η*)²=Tₑ*. The effective diameter (Dₑ) was previously defined based on the equivalent cylinder flow model, and may be redefined using the size factor and clogging factor of the equivalent concentric annulus flow model. Equation 8(e) shows the correlation between the variables of the concentric annulus flow model and the effective diameter of the equivalent cylinder model.

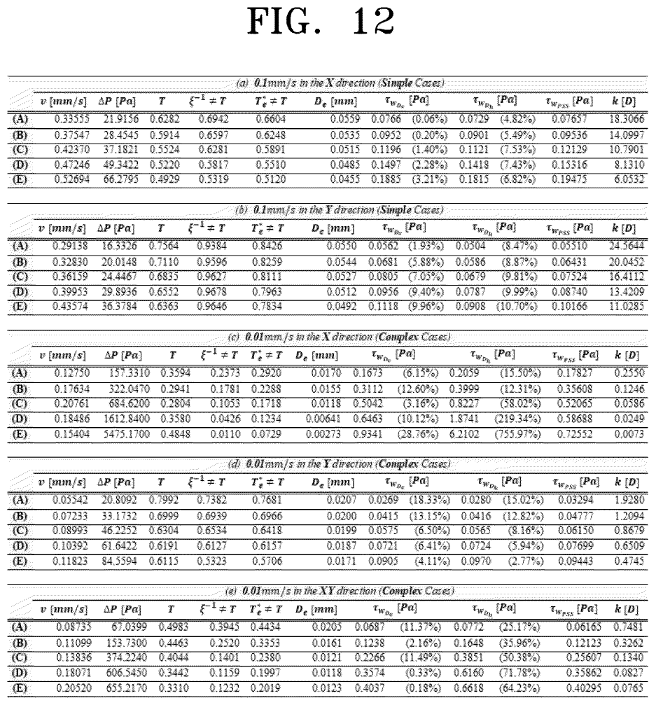

As shown in FIG. 12 below, initial variables such as the average interstitial flow velocity (v) and pressure difference (ΔP) were directly obtained from the pore-scale simulation results, and then each of the pore-scale simulation was performed with 200,000 uniformly distributed streamline seeds, thereby deriving the streamline distribution of the fluid.

FIG. 12 is a table showing variables derived from the pore-scale simulation results in the method of predicting permeability of porous material based on anisotropic flow model, according to an embodiment of the present invention.

Referring to FIG. 12, for the simple porous medium model above (simple cases), the variables for the X-direction and Y-direction for the apparent velocity (u) of 0.1 mm/s are shown. For the complex porous medium model above (complex cases), the variables for the X-direction, Y-direction and XY-direction for the apparent velocity (u) of 0.01 mm/s are shown. The pore-scale simulation results are totally 25. From the pore-scale simulation results, the average interstitial flow velocity (v) and pressure difference (ΔP) are obtained. Here, the average interstitial flow velocity (v) may be obtained from the length averaged streamline velocity from the pore-scale simulation results. In addition, derived variables such as hydraulic tortuosity, friction constant ratio, permeability, effective diameter, and effective tortuosity are summarized. These variables are obtained directly from the pore-scale simulation results or calculated using Equation 6 to Equation 9. Here, “v” is the average interstitial flow velocity obtained from the “length-averaged streamline velocity” of the pore-scale simulation results.

In order to verify the explanation of the effective diameter (Dₑ), the wall shear stress (τ_{WPSS}) that may be directly evaluated from the streamline of each pore-scale simulation result was obtained. Then, the theory of Darcy friction factor was combined with the Darcy-Weisbach equation, which is commonly used in conventional pipe flow analysis, to correlate the PSS wall shear stress (τ_{WPSS}) and the effective diameter (Dₑ), which is shown in Equation 9 below.

$$\begin{matrix}{f}_{u} = \frac{8 {τ}_{wpss}}{ρ {u}^{2}} \\ and \\ {f}_{u} = \frac{2 {D}_{pss}}{ρ {u}^{2}} \frac{Δ P}{L} \\ ∴ {τ}_{wpss} = \frac{{D}_{e}}{4} \frac{Δ P}{L} \\ where \\ {D}_{pss} ≡ {D}_{e}\end{matrix} \qquad 〈 Equation 9 〉$$

In Equation 9, fᵤ is a friction factor based on u, τ_{WPSS} is PSS wall shear stress, ρ is a fluid density, u is an apparent flow velocity, D_{PSS} is a PSS diameter, ΔP is a pressure difference, L is a porous medium length, and Dₑ is an effective diameter.

When the effective diameter of each pore-scale simulation model corresponds to a true equivalent diameter of the target porous medium, the PSS wall shear stress (τ_{WPSS}) may be equal to the effective wall shear stress (τ_{wDe}) calculated using Equation 9.

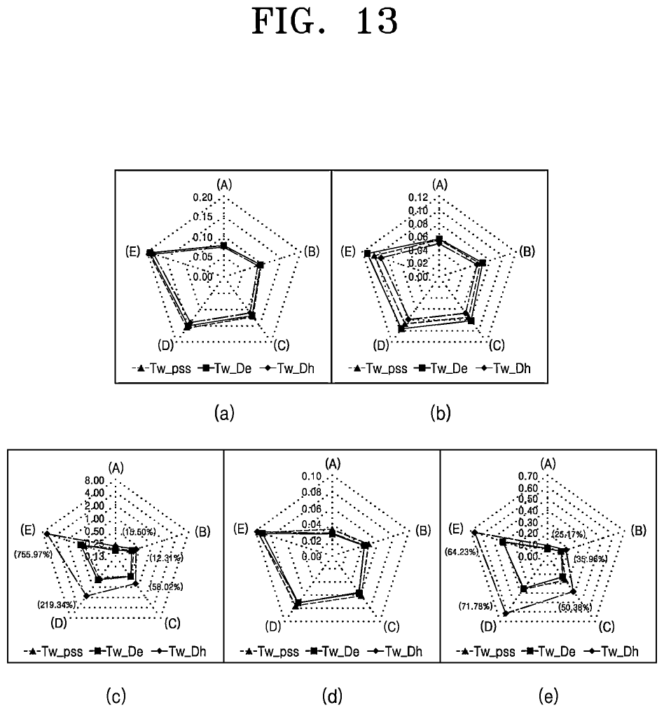

FIG. 13 is a graph comparing the wall shear stress derived from the pore-scale simulation results with the wall shear stress from the calculations in the method of predicting permeability of porous material based on anisotropic flow model, according to an embodiment of the present invention.

In FIG. 13, (a) shows the X-direction flow condition of the simple porous medium model, (b) shows the Y-direction flow condition of the simple porous medium model, (c) shows the X-direction flow condition of the complex porous medium model. (d) shows the Y-direction flow condition of the complex porous medium model, and (e) shows the XY-direction flow condition of the complex porous medium model.

Referring to FIG. 13, PSS wall shear stress (τ_{WPSS}), effective wall shear stress (τ_{wDe}), and hydraulic wall shear stress (τ_{wDh}) calculated using hydraulic diameter are shown. As a result, all effective wall shear stresses (τ_{wDe}) calculated based on the effective diameter are in good agreement with the PSS wall shear stress (τ_{WPSS}), so the effective wall shear stress (τ_{wDe}) is analyzed to be well verified. On the other hand, the hydraulic wall shear stress (τ_{wDh}) shows a large difference, and the error is particularly large in the case of the complex porous medium model. The maximum error in FIG. 13(c) was 756%, and the maximum error in FIG. 13(e) was 72%. Therefore, in order to properly define the true equivalent diameter of the porous medium, the definition of the effective diameter of Equation 6 may be confirmed by comparison with FIG. 13.

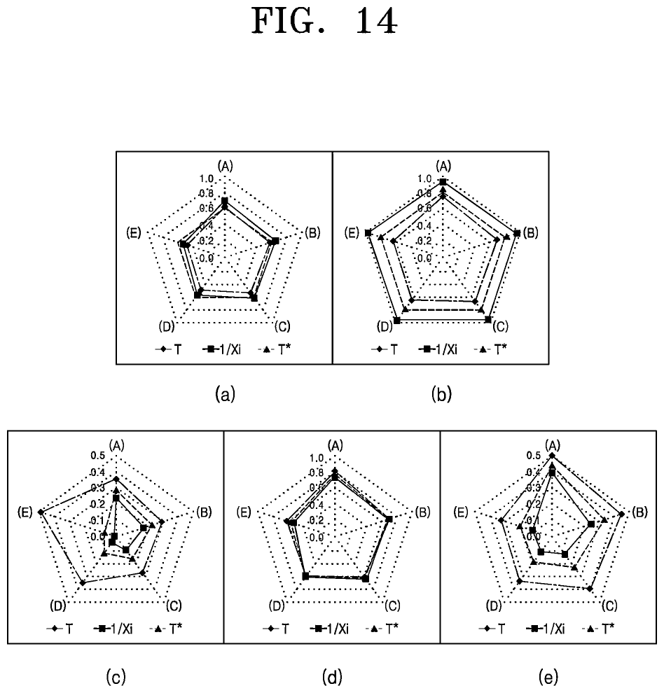

FIG. 14 is a graph comparing hydraulic tortuosity, the reciprocal of the friction ratio, and effective tortuosity in the method of predicting permeability of porous material based on anisotropic flow model, according to an embodiment of the present invention.

In FIG. 14, (a) shows the X-direction flow condition of the simple porous medium model, (b) shows the Y-direction flow condition of the simple porous medium model, (c) shows the X-direction flow condition of the complex porous medium model, (d) shows the Y-direction flow condition of the complex porous medium model, and (e) shows the XY-direction flow condition of the complex porous medium model.

Referring to FIG. 14, it was confirmed that the effective tortuosity (Tₑ*) does not match well with the hydraulic tortuosity (T). That is, Tₑ*=L/Lₑ*≠T=u/φv. Therefore, it is analyzed that a true equivalent flow model cannot be defined based on the hydraulic diameter. Therefore, the Kozeny-Carman equation is analyzed as insufficient. In other words, when the Kozeny constant is modified from “C_{K}” to “C_{K} T”, the true interstitial flow velocity is formed based on the hydraulic diameter. However, returning to the same definition of Kozeny permeability, the Carman correction is not required.

Additionally, it may be seen that in complex, irregular, and twisted pore paths, the hydraulic tortuosity (T) is not exactly proportional to the inverse of the friction constant ratio (1/ξ). That is, T≠1/ξ≠1/ξ* and Tₑ*²≠T². Therefore, Equation 4(b) and Equation 5(b), which are modified using effective diameter or effective tortuosity, are analyzed as appropriate as improved definitions of the Kozeny-Carman equation.

### Equivalent Model of Anisotropic Flow Through Porous Media

This study demonstrated that the effective diameter is essential to define the equivalent model of anisotropic flow passing through porous media. Therefore, all the equations of porous flows may be consistently defined on the basis of the effective diameter. First, the mass conservation equation in Equation 4 is redefined in Equation 10 based on the effective diameter.

$$〈 Equation 10 〉$$

$$\begin{matrix}{Q}_{u} = \frac{π {D}^{2}}{4} \cdot u & ( a ) \\ & \\ {Q}_{v} = \frac{π {D}_{h}^{2}}{4} \cdot v & \\ ∴ {D}^{2} \cdot u = {D}_{h}^{2} \cdot v & \\ ∵ {Q}_{u} = {Q}_{v} & \\ {V}_{u} = ∅ \cdot \frac{π {D}^{2}}{4} \cdot L & ( b ) \\ & \\ {V}_{v} = \frac{π {D}_{e}^{2}}{4} \cdot {L}_{e} & \\ ∴ {D}_{e}^{2} \cdot = {D}^{2} \cdot ∅ \cdot \frac{L}{{L}_{e}} & \\ ∵ {V}_{u} = {V}_{v} & \\ ∴ T = \frac{u}{∅ v} = \frac{L}{{L}_{e}} & ( c ) \\ ∵ {D}^{2} \cdot u = {D}_{e}^{2} \cdot v = {D}^{2} \cdot ∅ \frac{L}{{L}_{e}} \cdot v & \\ ∴ {D}_{e} = \frac{4 ∅}{{S}_{{s}_{e}}} = ∅ \cdot \frac{{D}^{2}}{{D}_{e}} \cdot \frac{L}{{L}_{e}} & ( d ) \\ and & \\ {S}_{{s}_{e}} = \frac{{S}_{e}}{{V}_{b}} = \frac{π {D}_{e} \cdot {L}_{e}}{( π {D}^{2} / 4 ) \cdot L} & \end{matrix}$$

In Equation 10, Qᵤ is medium-scale flow rate, D is a diameter of a control volume, u is an apparent flow velocity, Qᵥ is pore-scale flow rate, Dₑ is an effective diameter, v is an interstitial flow velocity, Vᵤ is a volume based on u, φ is porosity, L is a porous medium length, Vᵥ is a volume based on v, Lₑ is an actual pore flow length, T is hydraulic tortuosity, S_{S} is a specific surface area, S_{Se} is an effective specific surface area, Sₑ is an effective surface area, V_{b} is a porous medium volume.

In Equation 10(c), we may reconfirm the identical definition of hydraulic tortuosity with Kozeny's definition in Equation 3, while satisfying the mass conservation law. This is critical because the relationship between the interstitial flow velocity and path length may be correctly interpreted instead of using the tortuosity square relationship in the Kozeny-Carman equation. Moreover, the diameter of the equivalent control volume (D) may now be precisely determined using Equation 10; e.g., the control volume may be conceptually replaced with the equivalent cylinder, which has the exactly same internal velocity and pressure difference for the given flow rate. Here, the effective specific surface area (S_{Se}) was defined by coupling with the effective diameter.

Then, the macroscopic momentum conservation in Equation 1 is redefined on the basis of the effective diameter and presented in Equation 11, with the microscopic momentum conservation in Equation 12 already proved via the derivations of Equation 6.

$$〈 Equation 11 〉$$

$$\begin{matrix}u = - \frac{k}{μ} \frac{Δ P}{L} & ( a ) \\ and & \\ k = \frac{2 {D}_{e}^{2}}{{f}_{u} {Re}_{{u}_{e}}} & \\ where & \\ {f}_{{u}_{e}} = \frac{2 {D}_{e}}{ρ {u}^{2}} \frac{Δ P}{L} & \\ and & \\ {Re}_{{u}_{e}} = \frac{ρ {uD}_{e}}{μ} & \\ {f}_{{u}_{e}}^{2} = \frac{128 μ}{{ρ}^{2} {u}^{3} \cdot ∅ {T}^{2}} \frac{Δ P}{L} & ( b ) \\ & \\ {Re}_{{u}_{e}}^{2} = \frac{32 \cdot {ρ}^{2} {u}^{3}}{μ \cdot ∅ {T}^{2}} \frac{L}{Δ P} & \\ ∵ {D}_{e} = \frac{{D}_{h}}{{( T \cdot ξ )}^{0.5}} & \\ ∴ {f}_{{u}_{e}} {Re}_{{u}_{e}} = \frac{64}{∅ {T}^{2}} & \\ or & \\ {f}_{u} = \frac{8 {τ}_{{W}_{u}}}{ρ {u}^{2}} , & ( c ) \\ {τ}_{{W}_{u}} = \frac{{D}_{e}}{4} \frac{Δ P}{L} = {τ}_{wpss} & \\ & \\ {Re}_{{u}_{e}} = \frac{ρ {uD}_{h}}{μ} {( \frac{ϕ v}{ξ u} )}^{\frac{1}{2}} & \\ or & \\ {Re}_{{u}_{e}} = \frac{ρ u}{μ T} {( \frac{32 k}{ϕ} )}^{\frac{1}{2}} & \end{matrix}$$

In Equation 11, u is an apparent flow velocity, k is permeability, μ is a fluid viscosity, ΔP is a pressure difference, L is a porous medium length, Dₑ is an effective diameter, fᵤₑ is an effective friction factor based on u, Reᵤₑ is an effective Reynolds number based on u, ρ is a fluid density, φ is porosity, T is hydraulic tortuosity, Dₕ is a hydraulic diameter, ξ is a friction ratio, fᵤ is a friction factor based on u, τwᵤ is a wall shear stress based on u, τ_{WPSS} is PSS wall shear stress, and v is an interstitial flow velocity.

$$〈 Equation 12 〉$$

$$\begin{matrix}v = - \frac{2 {D}_{e}^{2}}{μ \cdot {f}_{e} {Re}_{e}} \frac{Δ P}{{L}_{e}} & ( a ) \\ and & \\ k = \frac{∅ \cdot {D}_{e}^{2} \cdot {T}^{2}}{32} & \\ where & \\ {f}_{e} = \frac{2 {D}_{e}}{ρ {v}^{2}} \frac{Δ P}{{L}_{e}} & \\ and & \\ {Re}_{v} = \frac{ρ v {D}_{h}}{μ} & \\ ∴ {f}_{e}^{2} = \frac{128 μ \cdot T}{{ρ}^{2} {v}^{3}} \frac{Δ P}{L} & ( b ) \\ and & \\ {Re}_{e}^{2} = \frac{32 \cdot {ρ}^{2} {v}^{3}}{μ \cdot T} \frac{L}{Δ P} & \\ ∴ {f}_{e} {Re}_{e} = {f}_{{u}_{e}} {Re}_{{u}_{e}} \cdot ∅ {T}^{2} = 64 & \\ or & \\ {f}_{v} = \frac{8 {τ}_{{W}_{v}}}{ρ {v}^{2}} , & ( c ) \\ {τ}_{{W}_{v}} = \frac{{D}_{e}}{4} \frac{Δ P}{{L}_{e}} = {τ}_{wpss} \cdot T & \\ & \\ {Re}_{e} = \frac{ρ {vD}_{h}}{μ} {( \frac{{ϕ}_{v}}{{ξ}_{u}} )}^{\frac{1}{2}} & \\ or & \\ {Re}_{e} = \frac{ρ v}{μ T} {( \frac{32 k}{ϕ} )}^{\frac{1}{2}} & \end{matrix}$$

In Equation 12, v is an interstitial flow velocity, Dₑ is an effective diameter, μ is a fluid viscosity, fₑ is an effective friction factor, Reₑ is an effective Reynolds number, ΔP is a pressure difference, Lₑ is an actual pore flow length, k is permeability, φ is porosity, T is hydraulic tortuosity, ρ is a fluid density, L is a porous medium length, fᵤₑ is an effective friction factor based on u, Reᵤₑ is an effective Reynolds number based on u, fᵤ is friction factor based on v, τwᵥ is a wall shear stress based on v, τ_{WPSS} is a PSS wall shear stress, Dₕ is a hydraulic diameter, ξ is a friction ratio, and u is an apparent flow velocity.

Equation 11(a) was experimentally verified using the PSS results, shown in FIGS. 12 and 13. Equation 12(a) was theoretically proved via the derivations of Equation 6.

Additionally, we may reconfirm that both equations are consistent using the identical correlation, fₑReₑ=fᵤₑReᵤₑ φT²=64, respectively expanded in Equations 11(b) and 12(b). Note that fᵥReᵥ=fᵤReᵤ φT²≠64. Finally, the correlations between the Darcy friction factor and wall shear stress, and the Reynolds number and permeability are summarized in Equations 11(c) and 12(c).

Therefore, all fundamental equations were corrected and most respective definitions were revised based on effective diameter. In particular, the permeability was redefined in Equations 11(a) and 12(a) using the truly equivalent diameter and path length, which vary according to each altered flow direction within an identical material. Moreover, some corrected definitions of the hydraulic tortuosity, Darcy friction factor, and Reynolds number produce suitable results based on the respective equivalent flow models according to each of the distinct, complex, invisible, and microscale pore paths.

As a result, the final porous flow model defined by introducing the effective diameter and hydraulic tortuosity definitions presented in the present invention is as shown in Equation 10, Equation 11, and Equation 12. Equation 10 presents the appropriateness and correlation of the derived effective diameter and hydraulic tortuosity definitions. Equation 11 defines the correlation between the geometric properties and the flow properties of the porous medium that may be utilized in actual flow analysis from a macroscopic perspective, i.e., based on the apparent flow velocity (u). Equation 12 defines the correlation from a microscopic perspective, i.e., based on the interstitial flow velocity (v). These correlations may be usefully utilized when estimating various rheological and geometric properties based on the properties measured in the field. In addition, the Reynolds number and friction constant may be used for objective comparisons and derivation of characteristics and parameters in various media flows by presenting each flow characteristic equally based on the cylindrical pipe flow.

In summary, in the present invention, the equivalent model of anisotropic porous flow was presented using the exact definitions of both effective diameter and Kozeny's hydraulic tortuosity. In particular, we infer that the hydraulic tortuosity (interstitial flow velocity) is the most critical and vital property to be determined for anisotropic frictional flow analyses. The length (Lₑ) of equivalent cylindrical flow model may be determined using the Kozeny's tortuosity definition and its diameter (Dₑ) may be defined in case that the interstitial flow velocity (v) is measured. Next, the anisotropic frictional features according to each different pore flow direction may be defined via the Darcy friction factor, Reynolds number, and friction constant (Kozeny constant) based on both the effective diameter and hydraulic tortuosity. Consequently, the revised Darcy friction factor may be used to fairly compare the individual frictional aspects owing to the complex viscous interactions within porous media. Moreover, the redefined Reynolds number may be used consistently as the criterion to distinguish flow regime and status while reflecting dramatic flow changes owing to the altered paths.

### Practical Approximation of the Interstitial Flow Velocity

Nevertheless, in reality, the interstitial flow velocity is rarely measured as it requires very complex and expensive procedures. Particularly, its measurement targeting actual groundwater, oil, and gas formations, which have huge, complex, microscale, and heterogeneous structures, is considerably difficult and less accurate, and thus, almost impossible to be achieved. Here, we may recall that the Kozeny-Carman equation produced large errors for the complex and tortuous media in low porosity. In particular, from the flow patterns and structures of the complex media shown in FIG. 9, the most distinct changes were the narrowed and closed pore paths. This means that frictional loss may be further increased owing to the reduced flow section in addition to the enlarged surface area which may be already reflected by the hydraulic diameter. Therefore, the increased frictional effect owing to the narrowed and closed path should be considered.

Accordingly, the concentric annulus flow model (ref. Method section M3) is additionally introduced to better estimate the effective diameter (Dₑ), wherein elongated pore flow length (tortuosity) within porous media is assumed to be proportional to the increased surface areas of inner and outer cylinders of the concentric annulus. The increased frictional losses owing to the narrowed sections are expected to be better reflected using the concentric annulus model, which may mimic the narrowed paths of real porous media more similarly on the basis of the calculable friction constant than cylindrical models. Here, the “special hydraulic annulus model” should be defined based on the hydraulic diameter (Dₕ) for the given flow condition (u and ΔP) because the interstitial velocity (v) is unknown; recall the “special hydraulic cylinder model” previously denoted using a superscripted *.

The inner and outer diameters may be simply determined by checking the same pressure difference for the determined effective tortuosity (T*=(1−η*)²=Tₑ*) while fixing the same conduit length (L) with the target medium.

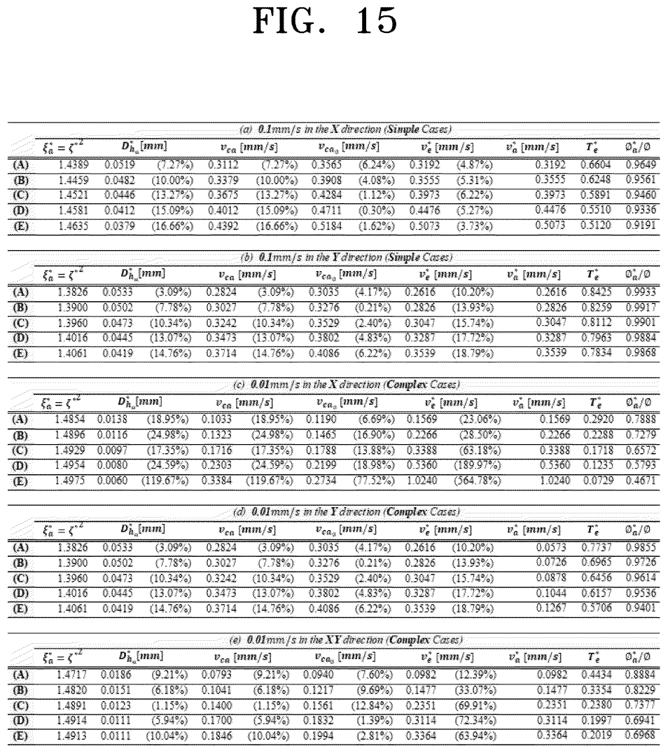

FIG. 15 is a table showing variables derived from the pore-scale simulation results using the special concentric annulus flow model in the method of predicting permeability of porous material based on anisotropic flow model, according to an embodiment of the present invention.

Referring to FIG. 15, the hydraulic diameters (Dₕₐ*) of each special concentric annulus flow model are listed for all 25 PSS models. Good agreements with the effective diameter (Dₑ≈Dₕₐ*) may be observed in most cases (0.2-25% errors), except the complex thinnest model with 119.7% error; the hydraulic diameter (Dₕ) overall gives much higher errors (up to 564.8% for the complex thinnest model).

Considering extreme difficulty in actual measurements of interstitial velocity, the approximations using the special concentric annulus model with the correlations in Equations 11 and 12 are remarkable. Notably, the interstitial velocity and hydraulic tortuosity of porous media may be reliably estimated using Equation 13 without measuring any internal flow property. In case that the effective diameter is estimated (Dₑ≈Dₕₐ*), all geometric and frictional flow variables, such as average path length, interstitial velocity, effective specific surface area, and Reynolds number, may be approximated using Equations 11 to 13, particularly for each distinct flow direction. Accordingly, the interstitial flow velocity

$$( ( {v}_{ca} = \frac{u}{∅ \cdot {T}_{ca}} = {v}_{α}^{*} \cdot {ξ}_{a}^{* \frac{1}{2}} \cdot {T}_{e}^{* \frac{1}{2}} ) )$$

was estimated via the hydraulic tortuosity

$$( ( {T}_{ca}^{2} = \frac{32 \cdot k}{∅ \cdot {D}_{{h}_{a}}^{* 2}} ) ,$$

improved to the correlation,

$${v}_{{ca}_{ϕ}} = {v}_{a}^{*} \cdot {{ξ}_{a}^{*}}^{\frac{1}{2}} \cdot {( \frac{{ϕ}_{a}^{*}}{ϕ} )}^{2} ,$$

and then compared with the true interstitial flow velocity (v) and special hydraulic velocity

$$( {v}_{e}^{*} = \frac{u}{ϕ \cdot {T}_{e}^{*}} )$$

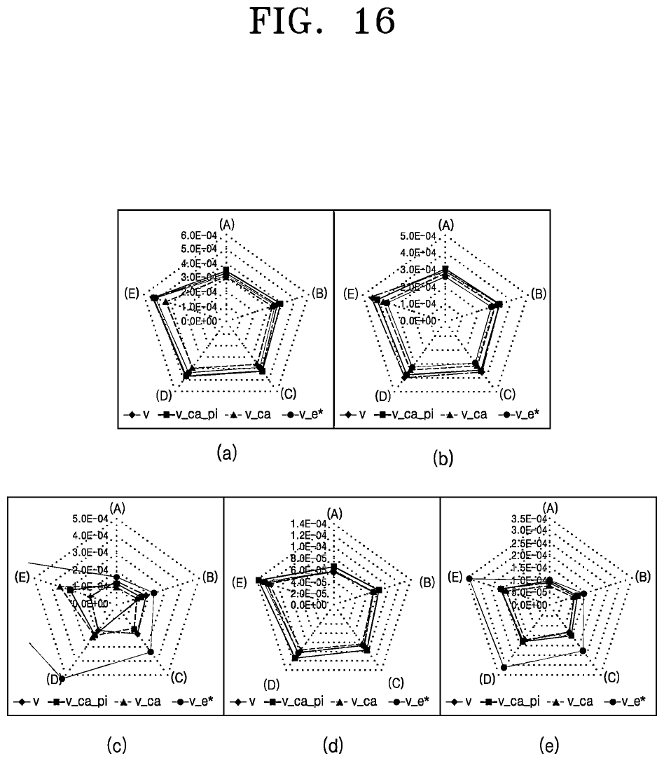

determined based on the special cylinder model, as summarized in FIG. 15 and plotted in FIG. 16.

FIG. 16 is a graph comparing interstitial flow velocities in the method of predicting permeability of porous material based on anisotropic flow model.

In FIG. 16, (a) shows the X-direction flow condition of the simple porous medium model, (b) shows the Y-direction flow condition of the simple porous medium model, (c) shows the X-direction flow condition of the complex porous medium model, (d) shows the Y-direction flow condition of the complex porous medium model, and (e) shows the XY-direction flow condition of the complex porous medium model.

Referring to FIG. 16, interstitial flow velocity (v), improved concentric annulus cylinder interstitial flow velocity (v_{caφ} or v_{capi}) combined with void ratio (φₐ/φ), concentric annulus cylinder interstitial flow velocity (v_{ca}), and superficial interstitial flow velocity (vₑ*) based on the hydraulic diameter (cylinder) model are shown.

FIG. 16 demonstrates both approximated values (v_{ca} and v_{caφ}) based on each hydraulic diameter (Dₕₐ*) of special concentric annulus model, indicating good agreements with the true values (v) for all PSS models. Otherwise, the special hydraulic velocity (vₑ*) (or an interstitial velocity of the special hydraulic cylinder model) gives large differences, particularly showing significant errors in complex cases (more realistic media model): 565% in FIG. 16 (c) and 72% in FIG. 16 (e) as maximum errors. Therefore, all frictional flow variables, such as the hydraulic tortuosity, Darcy friction factor, and Reynolds number, were reliably estimated for each anisotropic flow using the approximated interstitial velocity and effective diameter.

$$\begin{matrix}< Equation 13 > & \\ ∴ k = \frac{ϕ \cdot {{D}_{{h}_{a}}^{*}}^{2} \cdot {T}^{2}}{32} and {T}^{2} \approx {T}_{ca}^{2} = \frac{32 \cdot k}{ϕ \cdot {{D}_{{h}_{a}}^{*}}^{2}} where {D}_{e} \approx {D}_{{h}_{a}}^{*} & ( a )\end{matrix}$$

$$∴ v \approx {v}_{ca} = \frac{u}{ϕ {T}_{ca}} = \frac{u \cdot {D}_{{h}_{a}}^{*}}{{( 32 \cdot ϕ k )}^{0.5}} = {v}_{a}^{*} \cdot {{ξ}_{a}^{*}}^{\frac{1}{2}} \cdot {{T}_{e}^{*}}^{\frac{1}{2}} and {v}_{ca} \approx {v}_{ca ϕ} = {v}_{a}^{*} \cdot {{ξ}_{a}^{*}}^{\frac{1}{2}} \cdot {( \frac{{ϕ}_{a}}{ϕ} )}^{2} \qquad ( b )$$

In Equation 13, k is permeability, φ is porosity, Dₕₐ* is a concentric annulus cylinder hydraulic diameter of the special concentric annulus flow model, T is hydraulic tortuosity, T_{ca} is concentric annulus cylinder hydraulic tortuosity, Dₑ is an effective diameter, v is an interstitial flow velocity, v_{ca} is a concentric annulus cylinder interstitial flow velocity, u is an apparent flow velocity, vₐ* is a interstitial flow velocity of the special hydraulic concentric annulus flow model, ξₐ* is a friction ratio of the special hydraulic concentric annulus flow model, Tₑ* is effective tortuosity of the special hydraulic cylinder model, φₐ* is porosity of the special hydraulic concentric annulus flow model.

In the present invention, the anisotropic flow model of porous media was successfully presented using the exact definitions of the effective diameter and hydraulic tortuosity for accurate frictional flow analyses, and then their estimations were practically achieved by introducing the concentric annulus flow model. Particularly, the hydraulic diameter in the Kozeny-Carman equation was replaced with the effective diameter in the revised permeability relation, where both definitions of the hydraulic tortuosity and Kozeny constant were reasonably corrected. The new variables and relations are essential in practical porous flow analyses, such as geometric condition variations, flow regime changes, and anisotropic heat and multiphase flows through various porous media including water, oil, and gas reservoirs.

As described above, according to the technical spirit of the present invention, the characteristic variables and correlations for porous flow analysis are strictly presented. Nevertheless, there are still practical problems in actual porous flow analysis. That is, it is still difficult to measure the complex and minute internal porous flow velocity, i.e., the interstitial flow velocity (v), in most cases. In particular, measurement in a large reservoir is practically impossible. Therefore, the porous flow is defined as an equivalent cylinder flow model, but, i.e., fₑReₑ=64, the rheological variables of Equation 10 to Equation 12 cannot be defined. Therefore, in the present invention, a method is proposed to approximately calculate the internal gap velocity, hydraulic tortuosity, and effective diameter by additionally introducing a concentric annulus flow model (concentric annulus flow model). This is designed based on the assumption that the frictional flow characteristics experienced by the pore flow inside a porous medium are not simply a matter of the frictional surface area, and that the development of the viscous low layer, i.e., the distance, may also have a significant effect. In other words, even when experiencing frictional flow with the same solid surface area, the effect of the viscous region according to the size (distance) of each gap will be different in addition to the quantitative effect of the surface area, and it is expected that this may be more appropriately expressed by the concentric annulus flow model that may more effectively reflect the effect of the gap distance. As a result, the basic correlation of the concentric annulus flow model was introduced, and the special concentric annulus flow model (special concentric annulus flow model) defined under the special hydraulic conditions (special hydraulic condition) was confirmed to show very good agreement in all experimental cases, that is, Dₑ≈Dₕₐ*. In FIG. 16, the interstitial flow velocity was calculated using the relationship of Equation 13, and the starting point of this calculation is the relationship Dₑ≈Dₕₐ* derived from the special concentric annulus flow model.

Therefore, by defining the special concentric annulus cylinder model, the effective diameter may be determined from the relationship Dₑ≈Dₕₐ*, and the hydraulic tortuosity and internal flow velocity may be defined by utilizing the correlation of Equation 13. At this time, the permeability relationship, which was modified based on the existing Kozeny-Carman relationship, was presented as a new approximate permeability relationship by introducing the special concentric annulus cylinder hydraulic diameter, that is

$$k \approx \frac{ϕ \cdot {{D}_{{h}_{a}}}^{2} \cdot {T}^{2}}{32} .$$

In addition, it may be seen that the relationship

$${v}_{ca} \approx {v}_{ca ϕ} = {v}_{a}^{*} \cdot {{ξ}_{a}^{*}}^{\frac{1}{2}} \cdot {( \frac{{ϕ}_{a}^{*}}{ϕ} )}^{2}$$

shows better agreement in the case of the internal flow velocity.

As shown in Equations 14 and 15, the modified Comiti equation, which incorporates the effective diameters of porous media, was confirmed to be generally valid for the non-Darcy flow analyses composed of mono-size simple proppant packs. For actually using the modified Comiti equation, the effective diameter, hydraulic tortuosity, and the interstitial velocity must be provided, in which the concentric annulus flow model may be practically utilized.

$$∴ {f}_{p} {Re}_{p} = 16 + 0.1936 \cdot {Re}_{{p}^{′}} where {f}_{p} ≡ \frac{{D}_{e} \cdot {ϕ}^{2} {T}^{3}}{2 ρ {u}^{2}} \frac{Δ P}{L} {Re}_{p} ≡ \frac{ρ {uD}_{e}}{μ \cdot ϕ T} \qquad < Equation 14 >$$

In Equation 14, fₚ is friction factor of the proppant packs, Reₚ is a Reynolds number of the proppant packs, Dₑ is an effective diameter, φ is porosity, T is hydraulic tortuosity, ρ is a fluid density, u is an apparent flow velocity, ΔP is a pressure difference, L is a porous medium length, and μ is a fluid viscosity.

$$\begin{matrix}< Equation 15 > & \\ ∴ Δ P = ( 16 + 0.1936 \cdot \frac{ρ u}{μ \cdot ϕ {T}^{2}} ) \frac{2 μ uL}{ϕ} ∵ = {D}_{e} \cdot T {k}_{Daray} = \frac{ϕ \cdot }{32} & ( a )\end{matrix}$$

$$∴ k = \frac{ϕ}{2 ( 16 + 0.1936 \cdot \frac{ρ u}{μ \cdot ϕ {T}^{2}} )} or {T}^{2} = \frac{0.1936 \cdot \frac{ρ u}{μ \cdot ϕ {T}^{2}}}{( \frac{ϕ}{2 k} - 16 )} ∵ u = \frac{k}{μ} \frac{Δ P}{L} \qquad ( b )$$

In Equation 15, ΔP is a pressure difference, ρ is a fluid density, u is an apparent flow velocity, [symbol] is a superficial effective diameter, μ is a fluid viscosity, φ is porosity, T is hydraulic tortuosity, L is a porous medium length, Dₑ is an effective diameter, k_{Darcy} is Darcy permeability, and k is permeability.

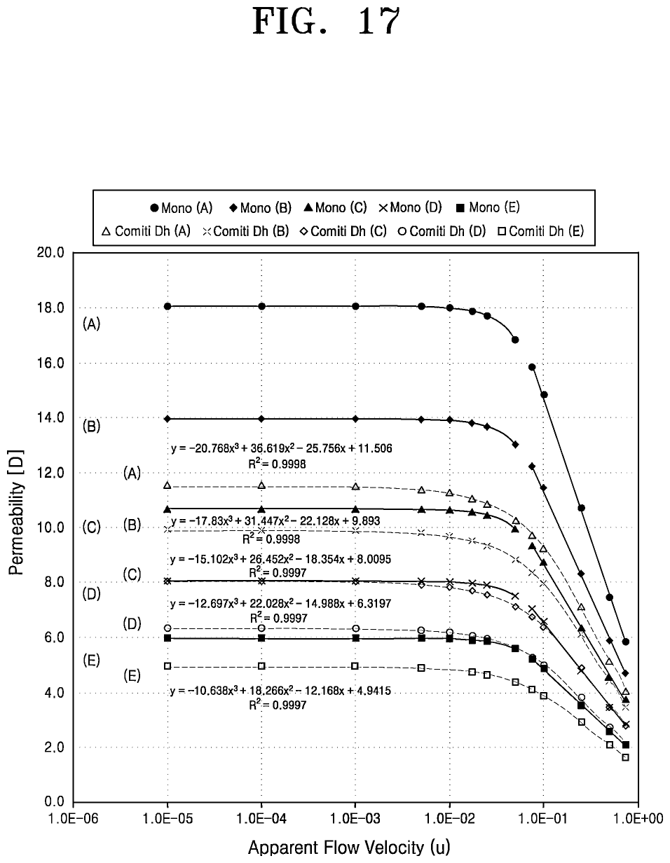

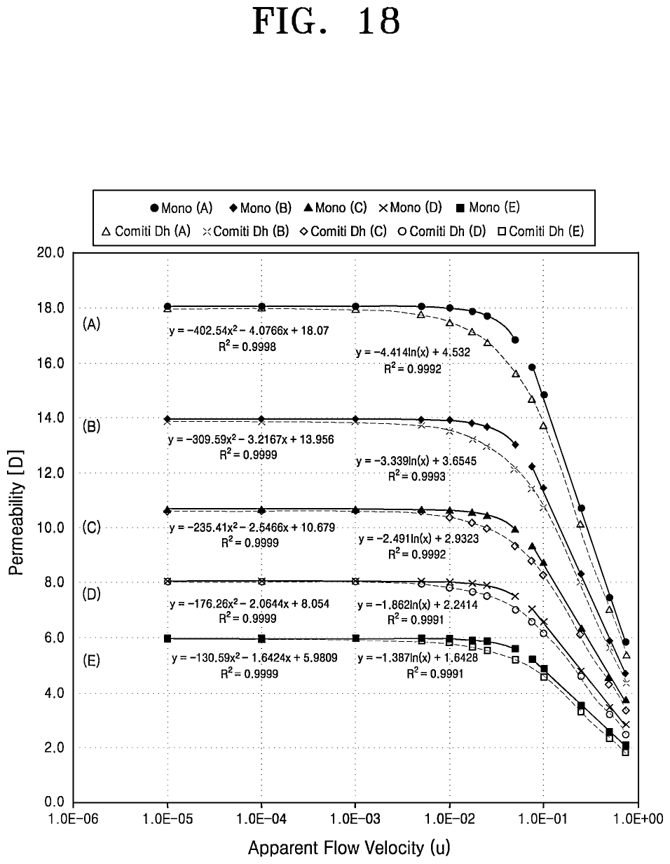

FIGS. 17 and 18 are graphs showing permeability for apparent flow velocity in the method of predicting permeability of porous material based on anisotropic flow model, according to an embodiment of the present invention.

In FIG. 17, the permeability variables obtained directly from the pore-scale simulation analysis for the increase in apparent flow velocity are shown as solid lines. The permeability variables of the single-layer model using the original Comiti equation based on the hydraulic diameter using Equation 1 are shown as dotted lines.

Referring to FIG. 17, the original Comiti model defined using the pore diameter shows a large difference.

In FIG. 18, the permeability variables obtained directly from the pore-scale simulation analysis for the increase in apparent flow velocity are shown as solid lines. The permeability variables of the single-layer model using the modified Comiti equation using Equation 15(b) are shown as dotted lines.

Referring to 18, it is verified that the modified Comiti equation results in reasonable permeability variations for the packed bed comprising mono-size proppants from the Darcy to non-Darcy flow regimes. Moreover, the equation indicates satisfactory outcomes not only in the original proppant pack ((A) thickest model) but also in the semi-consolidated packs ((B)-(E) models).

According to the results of FIG. 17 and FIG. 18, one of the fields where the necessity and utilization of the effective diameter derived in the present invention is most anticipated is Non-Darcy flow analysis. As shown in FIG. 17, the Comiti relationship has been presented and widely used in the past, but in reality, there are limitations in accurately measuring and presenting interstitial flow velocity or frictional resistance characteristics, so the hydraulic diameter (Dₕ) has been used as the basic variable of the Comiti relationship. However, it has been proven through numerical experiments that the results of FIG. 17 using the hydraulic diameter (Dₕ) show a considerable error. As shown in FIG. 18, it can be seen that the application of the effective diameter (Dₑ) is essential instead of the hydraulic diameter (Dₕ), and in all cases, the results show a very good agreement with the experimental results.

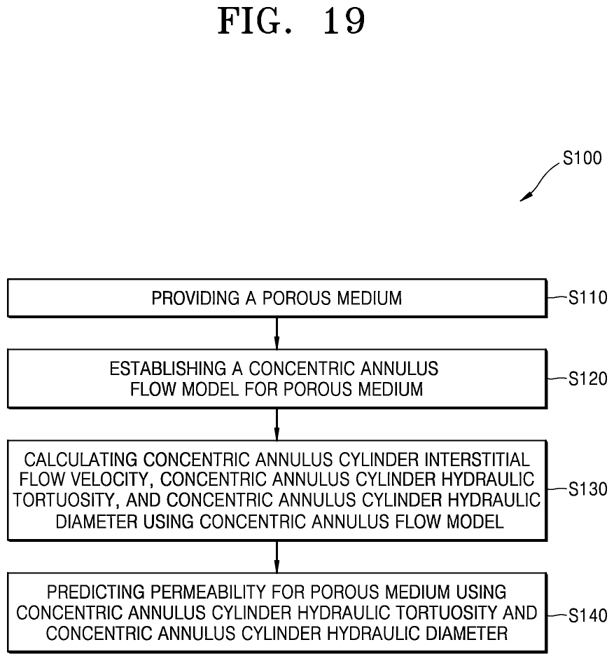

FIG. 19 is a flowchart of a method of predicting permeability of porous material based on anisotropic flow model, according to an embodiment of the present invention.

Referring to FIG. 19, the method (S100) of predicting permeability of porous material based on anisotropic flow model may include providing a porous medium (S110); establishing a concentric annulus flow model for the porous medium (S120); calculating a concentric annulus cylinder interstitial flow velocity, a concentric annulus cylinder hydraulic tortuosity, and a concentric annulus cylinder hydraulic diameter using the concentric annulus flow model (S130); and predicting a permeability for the porous medium using the concentric annulus cylinder hydraulic tortuosity and the concentric annulus cylinder hydraulic diameter (S140).

According to one embodiment of the present invention, the permeability may satisfy the following equation:

$$∴ k \approx \frac{ϕ \cdot {{D}_{{h}_{a}}^{*}}^{2} \cdot {T}^{2}}{32} and {T}^{2} \approx {T}_{ca}^{2} = \frac{32 \cdot k}{ϕ \cdot {{D}_{{h}_{a}}^{*}}^{2}} where {D}_{e} \approx {D}_{{h}_{a}}^{*}$$

where k is permeability, φ is porosity, Dₕₐ* is a concentric annulus cylinder hydraulic diameter of the special concentric annulus flow model, T is hydraulic tortuosity, T_{ca} is concentric annulus cylinder hydraulic tortuosity, and Dₑ is an effective diameter.

According to one embodiment of the present invention, the concentric annulus cylinder interstitial flow velocity may satisfy the following equation:

$$∴ v \approx {v}_{ca} = \frac{u}{ϕ {T}_{ca}} = \frac{u \cdot {D}_{{h}_{a}}^{*}}{{( 32 \cdot ϕ k )}^{0.5}} = {v}_{a}^{*} \cdot {{ξ}_{a}^{*}}^{\frac{1}{2}} \cdot {{T}_{e}^{*}}^{\frac{1}{2}} and {v}_{ca} \approx {v}_{ca ϕ} = {v}_{a}^{*} \cdot {{ξ}_{a}^{*}}^{\frac{1}{2}} \cdot {( \frac{{ϕ}_{a}}{ϕ} )}^{2}$$

where, v is an interstitial flow velocity, v_{ca} is a concentric annulus cylinder interstitial flow velocity, u is an apparent flow velocity, φ is porosity, T_{ca} is concentric annulus cylinder hydraulic tortuosity, Dₕₐ* is a concentric annulus cylinder hydraulic diameter of the special concentric annulus flow model, k is permeability, vₐ* is an interstitial flow velocity of the special concentric annulus flow model, ξₐ* is a friction ratio of the special hydraulic concentric annulus flow model, Tₑ* is effective tortuosity of the special hydraulic cylinder model, and φₐ* is porosity of the special hydraulic concentric annulus flow model.

According to one embodiment of the present invention, a medium-scale flow rate and a pore-scale flow rate flowing through the porous medium may satisfy the following equation, thereby obtaining a first correlation between a diameter of a control volume and an effective diameter:

$${Q}_{u} = \frac{π {D}^{2}}{4} \cdot u {Q}_{v} = \frac{π {D}_{h}^{2}}{4} \cdot v ∴ {D}^{2} \cdot u = {D}_{h}^{2} \cdot v ∵ {Q}_{u} = {Q}_{v}$$

where, Qᵤ is a medium-scale flow rate, D is a diameter of a control volume, u is an apparent flow velocity, Qᵥ is a pore-scale flow rate, Dₑ is an effective diameter, and v is an interstitial flow velocity.

According to one embodiment of the present invention, a volume for the interstitial flow velocity and a volume for the apparent flow velocity flowing through the porous medium may satisfy the following equation, thereby obtaining a first correlation between a diameter of a control volume and the effective diameter:

$${V}_{u} = ϕ \cdot \frac{π {D}^{2}}{4} \cdot L {V}_{v} = \frac{π {D}_{e}^{2}}{4} \cdot {L}_{e} ∴ {D}_{e}^{2} \cdot = {D}^{2} \cdot ϕ \cdot \frac{L}{{L}_{e}} ∵ {V}_{u} = {V}_{v}$$

where, u is an apparent flow velocity, v is an interstitial flow velocity, Vᵤ is a volume based on u, φ is porosity, D is a diameter of a control volume, L is a porous medium length, Vᵥ is a volume based on v, Dₑ is an effective diameter, and Lₑ is an actual pore flow length.

According to one embodiment of the present invention, hydraulic tortuosity may be derived using the following equation established by the first correlation and the second correlation:

$$∴ T = \frac{u}{ϕ v} = \frac{L}{{L}_{e}} ∵ {D}^{2} \cdot u = {D}_{e}^{2} \cdot v = {D}^{2} \cdot ϕ \cdot \frac{L}{{L}_{e}} \cdot v$$

where, T is hydraulic tortuosity, u is an apparent flow velocity, φ is porosity, v is an interstitial flow velocity, L is a porous medium length, Lₑ is an actual pore flow length, D is a diameter of a control volume, and Dₑ is an effective diameter.

According to one embodiment of the present invention, an effective diameter of the porous medium may satisfy the following equation:

$$∴ {D}_{e} = \frac{4 ϕ}{{S}_{{S}_{e}}} = ϕ \cdot \frac{{D}^{2}}{{D}_{e}} \cdot \frac{L}{{L}_{e}}$$

where, Dₑ is an effective diameter, φ is porosity, S_{Se} is an effective specific surface area, D is a diameter of a control volume, L is a porous medium length, and Lₑ is an actual pore flow length.

According to one embodiment of the present invention, an effective specific surface area of the porous medium may satisfy the following equation:

$${S}_{{S}_{e}} = \frac{{S}_{e}}{{V}_{b}} = \frac{π {D}_{e} \cdot {L}_{e}}{( π {D}^{2} / 4 ) \cdot L}$$

where, S_{Se} is an effective specific surface area, Sₑ is an effective surface area, V_{b} is a porous medium volume, Dₑ is an effective diameter, Lₑ is an actual pore flow length, D is a diameter of a control volume, and L is a porous medium length.

According to one embodiment of the present invention, an apparent flow velocity and permeability of the porous medium may satisfy the following equation:

$$u = - \frac{k}{μ} \frac{Δ P}{L} and k = \frac{2 {D}_{e}^{2}}{{f}_{u} {Re}_{{u}_{e}}}$$

where, u is an apparent flow velocity, k is permeability, μ is a fluid viscosity, ΔP is a pressure difference, L is a porous medium length, Dₑ is an effective diameter, fᵤₑ is an effective friction factor based on u, and Reᵤₑ is an effective Reynolds number based on u.

According to one embodiment of the present invention, the effective friction factor and the effective Reynolds number may satisfy the following equation:

$${f}_{{u}_{e}} = \frac{2 {D}_{e}}{ρ {u}^{2}} \frac{Δ P}{L}$$

$$and$$

$${Re}_{{u}_{e}} = \frac{ρ {uD}_{3}}{μ}$$

where, fᵤₑ is an effective friction factor based on u, Dₑ is an effective diameter, ρ is a fluid density, u is an apparent flow velocity, ΔP is a pressure difference, L is a porous medium length, Reᵤₑ is an effective Reynolds number based on u, Dₑ is an effective diameter, and μ is a fluid viscosity.

According to one embodiment of the present invention, the effective friction factor and the effective Reynolds number may satisfy the following equation:

$${f}_{{u}_{e}}^{2} = \frac{128 μ}{{ρ}^{2} {u}^{3} \cdot Φ {T}^{2}} \frac{Δ P}{L} {Re}_{{u}_{e}}^{2} = \frac{32 \cdot {ρ}^{2} {u}^{3}}{μ \cdot Φ {T}^{2}} \frac{L}{Δ P} ∵ {D}_{e} = \frac{{D}_{h}}{{( T \cdot ξ )}^{0.5}} ∴ {f}_{{u}_{e}} {Re}_{{u}_{e}} = \frac{64}{Φ {T}^{2}}$$

where, fᵤₑ is an effective friction factor based on u, μ is a fluid viscosity, ρ is a fluid density, u is an apparent flow velocity, φ is porosity, T is hydraulic tortuosity, ΔP is a pressure difference, L is a porous medium length, Reᵤₑ is an effective Reynolds number based on u, Dₑ is an effective diameter, Dₕ is a hydraulic diameter, and ξ is a friction ratio.

According to one embodiment of the present invention, the effective friction factor and the effective Reynolds number may satisfy the following equation:

$${f}_{u} = \frac{8 {τ}_{{w}_{u}}}{ρ {u}^{2}} ,$$

$${τ}_{{w}_{u}} = \frac{{D}_{e}}{4} \frac{Δ P}{L} = {τ}_{wpss} {Re}_{{u}_{e}} = \frac{ρ {uD}_{h}}{μ} {( \frac{Φυ}{ξ u} )}^{\frac{1}{2}}$$

$$or$$

$${Re}_{{u}_{e}} = \frac{ρ u}{μ T} {( \frac{32 k}{Φ} )}^{\frac{1}{2}}$$

where, fᵤ is a friction factor based on u, τwᵤ is a wall shear stress based on u, ρ is a fluid density, u is an apparent flow velocity, Dₑ is an effective diameter, ΔP is a pressure difference, L is a porous medium length, τ_{WPSS} is a PSS wall shear stress, Reᵤₑ is an effective Reynolds number based on u, Dₕ is a hydraulic diameter, μ is a fluid viscosity, φ is porosity, v is an interstitial flow velocity, ξ is a friction ratio, T is hydraulic tortuosity, and k is permeability.

According to one embodiment of the present invention, the interstitial flow velocity and the permeability of the porous medium may satisfy the following equation:

$$υ = - \frac{2 {D}_{e}^{2}}{μ \cdot {f}_{e} {Re}_{e}} \frac{Δ P}{{L}_{e}}$$

$$and$$

$$k = \frac{Φ \cdot {D}_{e}^{2} \cdot {T}^{2}}{32}$$

where, v is an interstitial flow velocity, Dₑ is an effective diameter, μ is a fluid viscosity, fₑ is an effective friction factor, Reₑ is an effective Reynolds number, ΔP is a pressure difference, Lₑ is an actual pore flow length, k is permeability, φ is porosity, and T is hydraulic tortuosity.

According to one embodiment of the present invention, the effective friction factor and the effective Reynolds number may satisfy the following equation:

$${f}_{e} = \frac{2 {D}_{e}}{{ρ}^{{υ}^{2}}} \frac{Δ P}{{L}_{e}}$$

$$and$$

$${Re}_{e} = \frac{ρ υ {D}_{e}}{μ}$$

where, fₑ is an effective friction factor, Dₑ is an effective diameter, ρ is a fluid density, v is an interstitial flow velocity, ΔP is a pressure difference, Lₑ is an actual pore flow length, Reₑ is an effective Reynolds number, and μ is a fluid viscosity.

According to one embodiment of the present invention, the effective friction factor and the effective Reynolds number may satisfy the following equation:

$$∴ {f}_{e}^{2} = \frac{128 μ \cdot T}{{p}^{2} {υ}^{3}} \frac{Δ P}{L}$$

$$and$$

$${Re}_{e}^{2} = \frac{32 \cdot {ρ}^{2} {υ}^{3}}{μ \cdot T} \frac{L}{Δ P} ∴ {f}_{e} {Re}_{e} = {f}_{{u}_{e}} {Re}_{{u}_{e}} \cdot Φ {T}^{2} = 64$$

where, fₑ is an effective friction factor, μ is a fluid viscosity, T is hydraulic tortuosity, ρ is a fluid density, v is an interstitial flow velocity, ΔP is a pressure difference, L is a porous medium length, Reₑ is an effective Reynolds number, fᵤₑ is an effective friction factor based on u, Reᵤₑ is an effective Reynolds number based on u, and φ is porosity.

According to one embodiment of the present invention, the effective friction factor and the effective Reynolds number may satisfy the following equation:

$${f}_{υ} = \frac{8 {τ}_{{w}_{υ}}}{ρ {υ}^{2}} ,$$

$${τ}_{{w}_{υ}} = \frac{{D}_{e}}{4} \frac{Δ P}{{L}_{e}} = {τ}_{wpss} \cdot T {Re}_{e} = \frac{ρ υ {D}_{h}}{μ} {( \frac{Φυ}{ξ u} )}^{\frac{1}{2}}$$

$$or$$

$${Re}_{e} = \frac{ρ υ}{μ T} {( \frac{32 k}{Φ} )}^{\frac{1}{2}}$$

where, fᵤ is a friction factor based on v, τwᵥ is a wall shear stress based on v, ρ is a fluid density, v is an interstitial flow velocity, Dₑ is an effective diameter, ΔP is a pressure difference, Lₑ is an actual pore flow length, τ_{WPSS} is a PSS wall shear stress, T is hydraulic tortuosity, Reₑ is an effective Reynolds number, Dₕ is a hydraulic diameter, μ is a fluid viscosity, φ is porosity, ξ is a friction ratio, u is an apparent flow velocity, and k is permeability.

According to one embodiment of the present invention, the friction factor and the Reynolds number of the porous medium may satisfy the following equation:

$$∴ {f}_{p} {Re}_{p} = 16 + 0.1936 \cdot {Re}_{{p}^{′}}$$

$$where$$

$${f}_{p} ≡ \frac{{D}_{e} \cdot {Φ}^{2} {T}^{3}}{2 ρ {u}^{2}} \frac{Δ P}{L} {Re}_{p} ≡ \frac{ρ u {D}_{e}}{μ \cdot Φ T}$$

where, fₚ is a friction factor of the proppant packs, Reₚ is a Reynolds number of the proppant packs, Dₑ is an effective diameter, φ is porosity, T is hydraulic tortuosity, ρ is a fluid density, u is an apparent flow velocity, ΔP is a pressure difference, L is a porous medium length, and μ is a fluid viscosity.

According to one embodiment of the present invention, a pressure difference of the porous medium may satisfy the following equation:

$$∴ Δ P = ( 16 + 0.1936 \cdot \frac{ρ u \overline{{D}_{e}}}{μ \cdot Φ {T}^{2}} ) \frac{2 μ uL}{Φ \overline{{D}_{e}^{2}}} ∵ \overline{{D}_{e}} = {D}_{e} \cdot T {k}_{Daray} = \frac{Φ \cdot \overline{{D}_{e}} {}^{2}}{32}$$

where, ΔP is a pressure difference, ρ is a fluid density, u is an apparent flow velocity, [symbol] is a superficial effective diameter, μ is a fluid viscosity, φ is porosity, T is hydraulic tortuosity, L is a porous medium length, Dₑ is an effective diameter, k_{Darcy} is Darcy permeability, and k is permeability.

According to one embodiment of the present invention, permeability and hydraulic tortuosity of the porous medium may satisfy the following equation:

$$∴ k = \frac{Φ \overline{{D}_{e}^{2}}}{2 ( 16 + 0.1936 \cdot \frac{ρ u \overline{{D}_{e}}}{μ \cdot Φ {T}^{2}} )}$$

$$or$$

$${T}^{2} = \frac{0.1936 \cdot \frac{ρ u \overline{{D}_{e}}}{μ \cdot Φ {T}^{2}}}{( \frac{Φ \overline{{D}_{e}^{2}}}{2 k} - 16 )} ∵ u = \frac{k}{μ} \frac{Δ P}{L}$$

where, k is permeability, φ is porosity, [symbol] is a superficial effective diameter, ρ is a fluid density, u is an apparent flow velocity, μ is a fluid viscosity, T is hydraulic tortuosity, ΔP is a pressure difference, and L is a porous medium length.

According to one embodiment of the present invention, the concentric annulus cylinder hydraulic diameter may be the same as the effective diameter of the porous medium, and the concentric annulus cylinder hydraulic tortuosity may be the same as the hydraulic tortuosity of the porous medium.

The technical spirit of the present invention described above may also be implemented as a computer-readable code in a computer-readable storage medium. A computer-readable storage medium includes all types of storage devices in which data readable by a computer system is stored. Examples of computer-readable storage media include ROM, RAM, CD-ROM, DVD, magnetic tape, floppy disk, optical data storage device, flash memory, etc., and also include those implemented in the form of carrier waves (e.g., transmission via the Internet). In addition, a computer-readable storage medium may be distributed to computer systems connected to a network, so that computer-readable code may be stored and executed in a distributed manner. Here, a program or code stored in a storage medium means something expressed as a series of instructions used directly or indirectly in a device having information processing capabilities, such as a computer, to obtain a specific result. Therefore, the term computer is also used to collectively mean all devices having information processing capabilities to perform a specific function by a program, including a memory, an input/output device, and an operation device, regardless of the actual name used.

When the method of predicting permeability of porous material based on anisotropic flow model, including steps of: providing a porous medium; establishing a concentric annulus flow model for the porous medium; calculating a concentric annulus cylinder interstitial flow velocity, a concentric annulus cylinder hydraulic tortuosity, and a concentric annulus cylinder hydraulic diameter using the concentric annulus flow model; and predicting a permeability for the porous medium using the concentric annulus cylinder hydraulic tortuosity and the concentric annulus cylinder hydraulic diameter, is performed on a computer, the computer-readable storage medium may store programmed commands to perform each of the above steps.

The technical spirit of the present invention described above is not limited to the foregoing embodiments and the accompanying drawings, and it will be clear to those skilled in the art to which the present invention pertains that various substitutions, modifications and changes are possible within the scope of the technical spirit of the present invention.

### NOMENCLATURE

C: Constant,
C_{K}: Kozeny Constant,
C_{S}: Shape Constant of Cross Section,
D: Diameter,
Dₘ: Grain (Matrix) D,
Dₕ: Hydraulic D,
Dₑ: Effective D,
[symbol] : Superficial Dₑ,
Dₐₒ: Annulus outer D,
Dₐᵢ: Annulus inner D,
Dₕₐ: Hydraulic D of Annulus Flow Model,
Dₕₐ*: Dₕₐ of Special Hydraulic Annulus (*),
f: Friction Factor,
fᵥ: f defined based on v,
h: Height(Thickness) of Porous Media,
k: Permeability; refer Equation (1),
L: Medium Length,
Lₑ: Actual Flow Length,
P: Pressure,
ΔP: Pressure Difference,
Q: Volumetric Flow Rate,
Qᵥ: Q defined for v,
Re: Reynolds Number,
Reᵥ: Re based on v,
S: Surface Area,
S_{S}: Specific Surface Area,
T: Hydraulic Tortuosity (T=L/Lₑ),
Tₑ*: Effective T,
Tₐ: Active T,
u: Apparent Flow Velocity through a Medium,
V: Volume,
V_{b}: Bulk Volume,
Vᵥ: V Based on v,
v: Interstitial (Internal) Velocity though Pores,
vₛ=u/φ: Superficial v for Straight Paths,
ζ: Sizing factor,
η: Clogging factor,
ξ: Friction Ratio,

$$ξ = \frac{{f}_{υ} {Re}_{υ}}{64} {C}_{k} = 2 ξ$$

$${ξ}_{a} = \frac{{( 1 - η )}^{2}}{{( 1 - η )}^{2} + \frac{{( 1 - η )}^{2}}{ln ( η )}} for Annulus Model$$

μ: Fluid Viscosity,
ρ: Fluid Density,
φ: Porosity; Pore V Ratio to Bulk V.
φₐ: Active φ,
τ_{w}: Wall Shear Stress,

### Sub-Script (Super-Script)

C: Carman, k_{C}: Carman's k,
e: Real, Lₑ: Real Flow Length, Effective (Dₑ, Tₑ*, vₑ, fₑReₑ),
h: Hydraulic Dₕ: Hydraulic Diameter,
K: Kozeny, k_{K}: Kozeny's k,
S: Specific, S_{S}: Specific Surface Area,
s: Superficial (vₛ=u/p): Superficial v,
u: Apparent Medium Flow Velocity,
v: Average Interstitial Flow Velocity,

### <Special Hydraulic Cylinder Model>

*:
Lₑ*≠Lₑ, υₑ*υ

$${T}_{e}^{⋆} = \frac{L}{{L}_{e}^{*}} = \frac{1}{{ξ}^{*}} \neq T$$

### PRIOR ART LITERATURE

Achdou, Y. and Avelaneda, M. (1992). Influence of pore roughness and pore-size dispersion in estimating the permeability of a porous medium from electrical measurements. Physics of Fluids (A) 4, 2651-2673.
Ahmadi, M. M., Mohammadi, S., and Hayati, A. N. (2011). Analytical derivation of tortuosity and permeability of monosized spheres: A volume averaging approach. Physical Review E. 83, 026312.
Allen, K. G., von Backstrom, T. W., and Kroger, D. G. (2013). Packed bed pressure drop dependence on particle shape, size distribution, packing arrangement and roughness. Powder Technology. 246, 590-600.
Alomar, O. R., Mendes, M. A., Trimis, D., and Ray, S. (2017). Numerical simulation of complete liquid-vapour phase change process inside porous media: A comparison between local thermal equilibrium and non-equilibrium models. International Journal of Thermal Science 112, 222-241.
Bear, J. Dynamics of fluids in porous media (American Elservier Pub. Inc. 1975), pp. 27-194.
Berkowitz, B. (2002). Characterizing flow and transport in fractured geological media: a review. Advanced Water Resources 25, 861-884.
Bird, G. A. Molecular gas dynamics and the direct simulation of gas flow, Oxford Engineering Science, (Oxford University Press, New York, 1994).
Blake, F. C. (1922). The resistance of packing to fluid flow. AIChE Journal 14, 415-422.
Carman, P. C. (1938). The determination of the specific surface of powders. J. Society of Chemical Industry 57(225), 225-234.
Cheng, Y., Ying, Y., Japip, S., Jiang, S. D., Chung, T. S., Zhang, S. and Zhao, D. (2018). Advanced porous materials in mixed matrix membranes. Advanced Materials. 30(47), 1802401.
Costa, A. (2006). Permeability-porosity relationship: a reexamination of the Kozeny-Carman equation based on a fractal pore-space geometry assumption. Geophysical Research Letters 33(2), L02318.
Deng, J., Li, H., Wang, S., Ding, D., Chen, M., Liu, C., and Bao, X. (2017). Multiscale structural and electronic control of molybdenum disulfide foam for highly efficient hydrogen production. Nature Communications 8, 14430.
Dong, Y., Sosna, B., Korup, O., Rosowski, F., and Horn, R. (2017). Investigation of radial heat transfer in a fixed-bed reactor: CFD simulations and profile Measurements. Chemical Engineering Journal 317, 204-214.
Erdim, E., Akgiray, O., and Demir, I. (2015). A revisit of pressure drop-flow rate correlations for packed beds of spheres. Powder Technology 283, 488-504.
Fair, G., Hatch, L. P., and Hudson, H. E. (1933). Fundamental factors governing the streamline flow of water through sand. American Water Works Association Journal 25, 1551-1556.
Gaol, C. L., Ganzer, L., Mukherjeeb, S., and Alkan, H. (2021). Investigation of clogging in porous media induced by microorganisms using a microfluidic application, Environ. Sci.: Water Resources Technology 7, 442.
Guo, Z., Fang, Q., Nong, M., and Ren, X. (2021). A novel Kozeny-Carman-based permeability model for hydrate-bearing sediments. Energy 234, 121203.
Jeong, H. Y., Jun, S. C., Cheon, J. Y., and Park, M. (2018). A review on clogging mechanisms and managements in aquifer storage and recovery (ASR) applications. Geoscience Journal 22, 667-679.
Kozeny, J. Ueberkapillareleitung des wassersimboden. Sitzungsberichte der Akademie der Wissenschaften in Wien. 136, 271-306, 1927.
Ma, J. (2015). Review of permeability evolution model for fractured porous media. J. Rock Mech. Geotechnical Engineering 7, 351-357.
Neild, D. A. and Bejan, A. Convection in porous media (Springer-Verlag. 1992), pp. 5-18.
Nemeca, D. and Levec, J. (2005). Flow through packed bed reactors: 1. Single-phase flow. Chemical Engineering Science 60, 6947-6957.
Nicolas, G. H. (2006). The limits of Navier-Stokes theory and kinetic extensions for describing small-scale gaseous hydrodynamics. Physics of Fluids 18, 111301.
Nooruddin, H. A. and Hossain, M. E. (2012). Modified Kozeny-Carmen correlation for enhanced hydraulic flow unit characterization. Journal of Petroleum Science and Engineering 80(1), 107-115.
Ozugumus, T., Mobedi, M., and Ozkai, U. (2014). Determination of Kozeny Constant Based on Porosity and Pore to Throat Size Ratio in Porous Medium with Rectangular Rods, Engineering Applications of Computational Fluid Mechanic, 8(2), 308-318.
Paterson, M. S. (1983). The equivalent channel model for permeability and resistivity in fluid saturated rock: a re-appraisal. Mechs. Matts. 2(4), 345-352.
Pelay, U., Luo, L., Fan, Y., Stitou, D., and Rood, M. (2017). Thermal energy storage systems for concentrated solar pore plants. Renewable Sustainable Energy Review 79, 82-100.
Safari, M., Ghoiami, R., Jami, M., Anathan, M. A., Rahimi, A., and Khur, W. S. (2021). Developing a porosity-permeability relationship for ellipsoidal grains: A correction shape factor for Kozeny-Carman's equation. Journal of Petroleum Scienceand Engineering 205, 108896.
Shah, R. K. and London, A. L. Laminar Flow Forced Convection in Ducts, (Academic, New York, 1979).
Shin, C. (2017). Tortuosity correction of Kozeny's hydraulic diameter of a porous medium. Physics of Fluids 29, 023104.
Shin, C. (2019). Permeability variations by changes in geometrical conditions. Physics of Fluids 31, 023104.
Shin, C. (2021). Permeability variation analysis using thesuperficial diameter correlation with porositychange. Physics of Fluids 33, 053108.
Shin, C. (2022). Application of the Effective Diameters of Porous Media to the Non-Darcy Flow Analyses. Scientific Reports 12:5321.
Sobieski, W., Zhang, Q., and Liu, C. (2012). Predicting tortuosity for airflow through porous beds consisting of randomly packed spherical particles. Transport in Porous Media 93(3), 431-451.
Thullner, M. (2010). Comparison of bioclogging effects in saturated porous media within one- and two-dimensional flow systems, Ecological Engineering 36(2), 176-196.
Valdez-Parada, F. J., Ochoa-Tapia, J. and Alvarez-Ramirez, J. (2009). Validity of the permeability Carman-Kozeny equation: A volume averaging approach. Physica A 388, 789-798.
Vogel, H. J. (2000). A numerical experiment on pore size, pore connectivity, water retention, permeability, and solute transport using network models. European Journal of Soil Science 51(1), 99-105.
Walsh, J. B. and Brace, W. F. (1984). The effect of pressure on porosity and the transport properties of rock. Journal of Geophysical Research 89(B111), 9425-9431.
Wei, W., Cai, J., Xiao, J., Meng, Q., Xaio, B., and Han, Q. (2018). Kozeny-Carman constant of porous media: Insights from fractal-capillary imbibition theory. Fuel 234, 1373-1379.
White, F. M. Fluid dynamics, 4th ed., (McGraw-Hill, New York, 2001) pp. 325-404.
Zhou, Y., Weng, S., Zhang, Y., Zhu, D. Z., Tang, P., and Xiang, Z. (2020). Experimental study of seepage flow properties with biofilm development in porous media with different filter morphologies, Journal of Hydrology. 591, 125596.
Zhu, Q. and Xuan, Y. (2017). Pore scale numerical simulation of heat transfer and flow in porous volumetric solar receivers. Applied Thermal Engineering 120, 25 150-159.

1. A method of predicting permeability of porous material based on anisotropic flow model, comprising:
providing a porous medium;
establishing a concentric annulus flow model for the porous medium;
calculating a concentric annulus cylinder interstitial flow velocity, a concentric annulus cylinder hydraulic tortuosity, and a concentric annulus cylinder hydraulic diameter using the concentric annulus flow model; and
predicting a permeability for the porous medium using the concentric annulus cylinder hydraulic tortuosity and the concentric annulus cylinder hydraulic diameter.

2. The method of predicting permeability of porous material based on anisotropic flow model according to claim 1, wherein the permeability satisfies the following equation:
$$∴ k \approx \frac{Φ \cdot {D}_{ha}^{* 2} \cdot {T}^{2}}{32}$$
$$and$$
$${T}^{2} \approx {T}_{ca}^{2} = \frac{32 \cdot k}{Φ \cdot {D}_{ha}^{* 2}}$$
$$where$$
$${D}_{e} \approx {D}_{ha}^{*}$$
where k is permeability, φ is porosity, Dₕₐ* is a concentric annulus cylinder hydraulic diameter of a special concentric annulus flow model, T is hydraulic tortuosity, T_{ca} is concentric annulus cylinder hydraulic tortuosity, and Dₑ is an effective diameter.

3. The method of predicting permeability of porous material based on anisotropic flow model according to claim 1, wherein the concentric annulus cylinder interstitial flow velocity satisfies the following equation:
$$∴ υ \approx {υ}_{ca} = \frac{u}{Φ {T}_{ca}} = \frac{u \cdot {D}_{ha}^{*}}{{( 32 \cdot Φ k )}^{0.5}} = {υ}_{a}^{*} \cdot {ξ}_{a}^{* \frac{1}{2}} \cdot {T}_{e}^{* \frac{1}{2}}$$
$$and$$
$${υ}_{ca} \approx {υ}_{ca Φ} = {υ}_{a}^{*} \cdot {ξ}_{a}^{* \frac{1}{2}} \cdot {( \frac{{Φ}_{a}}{Φ} )}^{2}$$
where, v is an interstitial flow velocity, v_{ca} is a concentric annulus cylinder interstitial flow velocity, u is an apparent flow velocity, φ is porosity, T_{ca} is concentric annulus cylinder hydraulic tortuosity, Dₕₐ* is a concentric annulus cylinder hydraulic diameter of a special concentric annulus flow model, k is permeability, vₐ* is an interstitial flow velocity of a special hydraulic concentric annulus flow model, ξₐ* is a friction ratio of the special hydraulic concentric annulus flow model, Tₑ* is effective tortuosity of a special hydraulic cylinder model, and φₐ* is porosity of the special hydraulic concentric annulus flow model.

4. The method of predicting permeability of porous material based on anisotropic flow model according to claim 1, wherein a medium-scale flow rate and a pore-scale flow rate flowing through the porous medium satisfy the following equation, thereby obtaining a first correlation between a diameter of a control volume and an effective diameter:
$${Q}_{u} = \frac{π {D}^{2}}{4} \cdot u {Q}_{υ} = \frac{π {D}_{h}^{2}}{4} \cdot υ ∴ {D}^{2} \cdot u = {D}_{h}^{2} \cdot υ ∵ {Q}_{u} = {Q}_{υ}$$
where, Qᵤ is a medium-scale flow rate, D is a diameter of a control volume, u is an apparent flow velocity, Qᵥ is a pore-scale flow rate, Dₑ is an effective diameter, and v is an interstitial flow velocity.

5. The method of predicting permeability of porous material based on anisotropic flow model according to claim 4, wherein a volume for the interstitial flow velocity and a volume for the apparent flow velocity flowing through the porous medium satisfy the following equation, thereby obtaining a first correlation between a diameter of a control volume and an effective diameter:
$${V}_{u} = ϕ \cdot \frac{π {D}^{2}}{4} \cdot L {V}_{v} = \frac{π {D}_{e}^{2}}{4} \cdot {L}_{e} ∴ {D}_{e}^{2} \cdot = {D}^{2} \cdot ϕ \cdot \frac{L}{{L}_{e}} ∵ {V}_{u} = {V}_{v}$$
where, u is an apparent flow velocity, v is an interstitial flow velocity, Vᵤ is a volume based on u, φ is porosity, D is a diameter of a control volume, L is a porous medium length, Vᵥ is a volume based on v, Dₑ is the effective diameter, and Lₑ is an actual pore flow length.

6. The method of predicting permeability of porous material based on anisotropic flow model according to claim 5, wherein hydraulic tortuosity is derived using the following equation established by the first correlation and the second correlation:
$$∴ T = \frac{u}{ϕ v} = \frac{L}{{L}_{e}} ∵ {D}^{2} \cdot u = {D}_{e}^{2} \cdot v = {D}^{2} \cdot ϕ \cdot \frac{L}{{L}_{e}} \cdot v$$
where, T is hydraulic tortuosity, u is an apparent flow velocity, φ is porosity, v is an interstitial flow velocity, L is a porous medium length, Lₑ is an actual pore flow length, D is a diameter of a control volume, and Dₑ is an effective diameter.

7. The method of predicting permeability of porous material based on anisotropic flow model according to claim 1, wherein an effective diameter of the porous medium satisfies the following equation:
$$∴ {D}_{e} = \frac{4 ϕ}{{S}_{{S}_{e}}} = ϕ \cdot \frac{{D}^{2}}{{D}_{e}} \cdot \frac{L}{{L}_{e}}$$
where, Dₑ is an effective diameter, φ is porosity, S_{Se} is an effective specific surface area, D is a diameter of a control volume, L is a porous medium length, and Lₑ is an actual pore flow length.

8. The method of predicting permeability of porous material based on anisotropic flow model according to claim 1, wherein an effective specific surface area of the porous medium satisfies the following equation:
$${S}_{{S}_{e}} = \frac{{S}_{e}}{{V}_{b}} = \frac{π {D}_{e} \cdot {L}_{e}}{( π {D}^{2} / 4 ) \cdot L}$$
where, S_{Se} is an effective specific surface area, Sₑ is an effective surface area, V_{b} is a porous medium volume, Dₑ is an effective diameter, Lₑ is an actual pore flow length, D is a diameter of a control volume, and L is a porous medium length.

9. The method of predicting permeability of porous material based on anisotropic flow model according to claim 1, wherein an apparent flow velocity and permeability of the porous medium satisfy the following equation:
$$u = - \frac{k}{μ} \frac{Δ P}{L} and k = \frac{2 {D}_{e}^{2}}{{f}_{u} {Re}_{{u}_{e}}}$$
where, u is an apparent flow velocity, k is permeability, μ is a fluid viscosity, ΔP is a pressure difference, L is a porous medium length, Dₑ is an effective diameter, fᵤₑ is an effective friction factor based on u, and Reᵤₑ is an effective Reynolds number based on u.

10. The method of predicting permeability of porous material based on anisotropic flow model according to claim 9, wherein the effective friction factor and the effective Reynolds number satisfy the following equation:
$${f}_{{u}_{e}} = \frac{2 {D}_{e}}{ρ {u}^{2}} \frac{Δ P}{L} and {Re}_{{u}_{e}} = \frac{ρ {uD}_{e}}{μ}$$
where, fᵤₑ is an effective friction factor based on u, Dₑ is an effective diameter, ρ is a fluid density, u is an apparent flow velocity, ΔP is a pressure difference, L is a porous medium length, Reᵤₑ is an effective Reynolds number based on u, Dₑ is an effective diameter, and μ is a fluid viscosity.

11. The method of predicting permeability of porous material based on anisotropic flow model according to claim 9, wherein the effective friction factor and the effective Reynolds number satisfy the following equation:
$${f}_{{u}_{e}}^{2} = \frac{128 μ}{{ρ}^{2} {u}^{3} \cdot ϕ {T}^{2}} \frac{Δ P}{L} {Re}_{{u}_{e}}^{2} = \frac{32 \cdot {ρ}^{2} {u}^{3}}{μ \cdot ϕ {T}^{2}} \frac{L}{Δ P} ∵ {D}_{e} = \frac{{D}_{h}}{{( T \cdot ξ )}^{0.5}} ∴ {f}_{{u}_{e}} {Re}_{{u}_{e}} = \frac{64}{ϕ {T}^{2}}$$
where, fᵤe is an effective friction factor based on u, μ is a fluid viscosity, ρ is a fluid density, u is an apparent flow velocity, φ is porosity, T is hydraulic tortuosity, ΔP is a pressure difference, L is a porous medium length, Reᵤₑ is an effective Reynolds number based on u, Dₑ is an effective diameter, Dₕ is a hydraulic diameter, and ξ is a friction ratio.

12. The method of predicting permeability of porous material based on anisotropic flow model according to claim 9, wherein the effective friction factor and the effective Reynolds number satisfy the following equation:
$${f}_{u} = \frac{8 {τ}_{{w}_{u}}}{ρ {u}^{2}} , {τ}_{{w}_{u}} = \frac{{D}_{e}}{4} \frac{Δ P}{L} = {τ}_{wpss} {Re}_{{u}_{e}} = \frac{ρ {uD}_{h}}{μ} {( \frac{ϕ v}{ξ u} )}^{\frac{1}{2}} or {Re}_{{u}_{e}} = \frac{ρ u}{μ T} {( \frac{32 k}{ϕ} )}^{\frac{1}{2}}$$
where, fᵤ is a friction factor based on u, τwᵤ is a wall shear stress based on u, ρ is a fluid density, u is an apparent flow velocity, Dₑ is an effective diameter, ΔP is a pressure difference, L is a porous medium length, τ_{WPSS} is a PSS wall shear stress, Reᵤₑ is an effective Reynolds number based on u, Dₕ is a hydraulic diameter, μ is a fluid viscosity, φ is porosity, v is an interstitial flow velocity, ξ is a friction ratio, T is hydraulic tortuosity, and k is permeability.

13. The method of predicting permeability of porous material based on anisotropic flow model according to claim 1, wherein the interstitial flow velocity and the permeability of the porous medium satisfy the following equation:
$$v = - \frac{2 {D}_{e}^{2}}{μ \cdot {f}_{e} {Re}_{e}} \frac{Δ P}{{L}_{e}} and k = \frac{ϕ \cdot {D}_{e}^{2} \cdot {T}^{2}}{32}$$
where, v is an interstitial flow velocity, Dₑ is an effective diameter, μ is a fluid viscosity, fₑ is an effective friction factor, Reₑ is an effective Reynolds number, ΔP is a pressure difference, Lₑ is an actual pore flow length, k is permeability, φ is porosity, and T is hydraulic tortuosity.

14. The method of predicting permeability of porous material based on anisotropic flow model according to claim 13, wherein the effective friction factor and the effective Reynolds number satisfy the following equation:
$${f}_{e} = \frac{2 {D}_{e}}{{ρ}^{{v}^{2}}} \frac{Δ P}{{L}_{e}} and {Re}_{e} = \frac{ρ {vD}_{e}}{μ}$$
where, fₑ is an effective friction factor, Dₑ is an effective diameter, ρ is a fluid density, v is an interstitial flow velocity, ΔP is a pressure difference, Lₑ is an actual pore flow length, Reₑ is an effective Reynolds number, and μ is a fluid viscosity.

15. The method of predicting permeability of porous material based on anisotropic flow model according to claim 13, wherein the effective friction factor and the effective Reynolds number satisfy the following equation:
$$∴ {f}_{e}^{2} = \frac{128 μ \cdot T}{{ρ}^{2} {v}^{3}} \frac{Δ P}{L} and {Re}_{e}^{2} = \frac{32 \cdot {ρ}^{2} {v}^{3}}{μ \cdot T} \frac{L}{Δ P} ∴ {f}_{e} {Re}_{e} = {f}_{{u}_{e}} {Re}_{{u}_{e}} \cdot ϕ {T}^{2} = 64$$
where, fₑ is an effective friction factor, μ is a fluid viscosity, T is hydraulic tortuosity, ρ is a fluid density, v is an interstitial flow velocity, ΔP is a pressure difference, L is a porous medium length, Reₑ is an effective Reynolds number, fᵤₑ is an effective friction factor based on u, Reᵤₑ is an effective Reynolds number based on u, and φ is porosity.

16. The method of predicting permeability of porous material based on anisotropic flow model according to claim 13, wherein the effective friction factor and the effective Reynolds number satisfy the following equation:
$${f}_{v} = \frac{8 {τ}_{{w}_{v}}}{ρ {v}^{2}} , {τ}_{{w}_{v}} = \frac{{D}_{e}}{4} \frac{Δ P}{{L}_{e}} = {τ}_{wpss} \cdot T {Re}_{e} = \frac{ρ {vD}_{h}}{μ} {( \frac{ϕ v}{ξ u} )}^{\frac{1}{2}} or {Re}_{e} = \frac{ρ v}{μ T} {( \frac{32 k}{ϕ} )}^{\frac{1}{2}}$$
where, fᵤ is a friction factor based on v, τwᵥ is a wall shear stress based on v, ρ is a fluid density, v is an interstitial flow velocity, Dₑ is an effective diameter, ΔP is a pressure difference, Lₑ is an actual pore flow length, τ_{WPSS} is a PSS wall shear stress, T is hydraulic tortuosity, Reₑ is an effective Reynolds number, Dₕ is a hydraulic diameter, μ is a fluid viscosity, φ is porosity, ξ is a friction ratio, u is an apparent flow velocity, and k is permeability.

17. The method of predicting permeability of porous material based on anisotropic flow model according to claim 1, wherein a friction factor and a Reynolds number of the porous medium satisfy the following equation:
$$∴ {f}_{p} {Re}_{p} = 16 + 0.1936 \cdot {Re}_{p} \cdot where {f}_{p} ≡ \frac{{D}_{e} \cdot {ϕ}^{2} {T}^{3}}{2 ρ {u}^{2}} \frac{Δ P}{L} {Re}_{p} ≡ \frac{ρ {uD}_{e}}{μ \cdot ϕ T}$$
where, fₚ is the friction factor of proppant packs, Reₚ is the Reynolds number of the proppant packs, Dₑ is an effective diameter, φ is porosity, T is hydraulic tortuosity, ρ is a fluid density, u is an apparent flow velocity, ΔP is a pressure difference, L is a porous medium length, and μ is a fluid viscosity.

18. The method of predicting permeability of porous material based on anisotropic flow model according to claim 1, wherein a pressure difference of the porous medium satisfies the following equation:
$$∴ Δ P = ( 16 + 0.1936 \cdot \frac{ρ u}{μ \cdot ϕ {T}^{2}} ) \frac{2 μ uL}{ϕ} ∵ = {D}_{e} \cdot T {k}_{Daray} = \frac{ϕ \cdot }{32}$$
where, ΔP is a pressure difference, ρ is a fluid density, u is an apparent flow velocity, [symbol] is a superficial effective diameter, μ is a fluid viscosity, φ is porosity, T is hydraulic tortuosity, L is a porous medium length, Dₑ is an effective diameter, k_{Darcy} is Darcy permeability, and k is permeability.

19. The method of predicting permeability of porous material based on anisotropic flow model according to claim 1, wherein permeability and hydraulic tortuosity of the porous medium satisfy the following equation:
$$∴ k = \frac{ϕ}{2 ( 16 + 0.1936 \cdot \frac{ρ u}{μ \cdot ϕ {T}^{2}} )} or {T}^{2} = \frac{0.1936 \cdot \frac{ρ u}{μ \cdot ϕ {T}^{2}}}{( \frac{ϕ}{2 k} - 16 )} ∵ u = \frac{k}{μ} \frac{Δ P}{L}$$
where, k is permeability, φ is porosity, [symbol] is a superficial effective diameter, ρ is a fluid density, u is an apparent flow velocity, μ is a fluid viscosity, T is hydraulic tortuosity, ΔP is a pressure difference, and L is a porous medium length.

20. The method of predicting permeability of porous material based on anisotropic flow model according to claim 1, wherein the concentric annulus cylinder hydraulic diameter is the same as an effective diameter of the porous medium, and the concentric annulus cylinder hydraulic tortuosity is the same as the hydraulic tortuosity of the porous medium.
